(19) United States
(12) Patent Application Publication
(10) Pub. No.: US 2024/0181657 A1
(43) Pub. Date: Jun. 6, 2024

(54) SYSTEMS AND METHODS FOR OBJECT GRASPING

(71) Applicant: MUJIN, INC., Tokyo (JP)

(72) Inventors: Lei LEI, Guangzhou (CN); Yizuan ZHANG, Guangzhou (CN); Zhili LAI, Guangzhou (CN); Guohao HUANG, Guangzhou (CN); Mingjian LIANG, Guangzhou (CN); Shekhar GUPTA, Tokyo (JP)

(21) Appl. No.: 18/526,414

(22) Filed: Dec. 1, 2023

Related U.S. Application Data
(60) Provisional application No. 63/385,906, filed on Dec. 2, 2022.

(51) Int. Cl. B25J 15/06; B25J 9/16; G06V 20/50; G06V 20/60

(52) U.S. Cl. CPC B25J 15/0616; B25J 9/1697; G06V 20/50; G06V 20/60

(57) ABSTRACT

Systems, devices, and methods are provided herein for object gripping techniques by robotic end effectors. The systems, devices, and methods provided herein allow for object gripping techniques that include both suction and pinch gripping to facilitate the gripping of objects, including soft, deformable, and bagged objects. Further provided are systems, devices, and methods for adjusting gripping spans of multi-gripper end effectors.

### RELATED APPLICATIONS

This application claims priority to U.S. Provisional Application No. 63/385,906, filed Dec. 2, 2022 which is hereby incorporated herein in its entirety.

### FIELD OF THE INVENTION

The present technology is directed generally to robotic systems and, more specifically, to systems, processes, and techniques for grasping objects. More particularly, the present technology may be used for grasping flexible, wrapped, or bagged objects.

### BACKGROUND

With their ever-increasing performance and lowering cost, many robots (e.g., machines configured to automatically/autonomously execute physical actions) are now extensively used in various different fields. Robots, for example, can be used to execute various tasks (e.g., manipulate or transfer an object through space) in manufacturing and/or assembly, packing and/or packaging, transport and/or shipping, etc. In executing the tasks, the robots can replicate human actions, thereby replacing or reducing human involvements that are otherwise required to perform dangerous or repetitive tasks.

There remains a need for improved techniques and devices for grasping, moving, relocating, and robotically object with different form factors.

### SUMMARY

In an embodiment, a robotic grasping system including a robotic arm, a suction gripping device connected to the actuator arm, and a pinch gripping device connected to the actuator arm is provided.

In another embodiment, robotic grasping system including an actuator hub; a plurality of extension arms extending from the actuator hub in an at least a partially lateral orientation; and a plurality of gripping devices arranged at the ends is provided.

In some aspects, the techniques described herein relate to a robotic grasping system including an actuator arm; a suction gripping device; and a pinch gripping device.

In some aspects, the techniques described herein relate to a robotic grasping system including an actuator hub; a plurality of extension arms extending from the robotic hub in an at least a partially lateral orientation; and a plurality of gripping devices arranged at ends of the plurality of extension arms.

In some aspects, the techniques described herein relate to a robotic system for grasping objects, including: at least one processing circuit; and an end effector apparatus including: an actuator hub, a plurality of extension arms extending from the actuator hub in an at a least partially lateral orientation, a plurality of gripping devices arranged at corresponding ends of the extension arms, wherein the actuator hub includes one or more actuators couple to corresponding extension arms, the one or more actuators being configured to rotate the plurality of extension arms such that a gripping span of the plurality of gripping devices is adjusted, and a robot arm controlled by the at least one processing circuit and configured for attachment to the end effector apparatus, wherein the at least one processing circuit is configured to provide: a first command to cause at least one of the plurality of gripping devices to engage suction gripping, and a second command to cause at least one of the plurality of gripping devices to engage pinch gripping.

In some aspects, the techniques described herein relate to a robotic control method, for gripping a deformable object, operable by at least one processing circuit via a communication interface configured to communicate with a robot having a robot arm that includes an end effector apparatus having a plurality of movable dual gripping devices, each dual gripping device including a suction gripping device and a pinch gripping device, the method including: receiving image information describing the deformable object, wherein the image information is generated by a camera; performing, based on the image information, an object identification operation to generate grasping information for determining an object grasping command to grip the deformable object; outputting the object grasping command to the end effector apparatus, the object grasping command including: a dual gripping device movement command configured to cause the end effector apparatus to move each of the plurality of dual gripping devices to a respective engagement position, each dual gripping device being configured to engage the deformable object when moved to the respective engagement position; a suction gripping command configured to cause each dual gripping device to engage suction gripping of the deformable object using a respective suction gripping device; and a pinch gripping command configured to cause each dual gripping device to engage pinch gripping of the deformable object using a respective pinch gripping device; and outputting a lift object command configured to cause the robot arm to lift the deformable object.

In some aspects, the techniques described herein relate to a non-transitory computer-readable medium, configured with executable instructions for implementing a robot control method for gripping a deformable object, operable by at least one processing circuit via a communication interface configured to communicate with a robot having a robot arm that includes an end effector apparatus having a plurality of movable dual gripping devices, each dual gripping device including a suction gripping device and a pinch gripping device, the method including: receiving image information describing the deformable object, wherein the image information is generated by a camera; performing, based on the image information, an object identification operation to generate grasping information for determining an object grasping command to grip the deformable object; outputting the object grasping command to the end effector apparatus, the object grasping command including: a dual gripping device movement command configured to cause the end effector apparatus to move each of the plurality of dual gripping devices to a respective engagement position, each dual gripping device being configured to engage the deformable object when moved to the respective engagement position; a suction gripping command configured to cause each dual gripping device to engage suction gripping of the deformable object using a respective suction gripping device; and a pinch gripping command configured to cause each dual gripping device to engage pinch gripping of the deformable object using a respective pinch gripping device; and outputting a lift object command configured to cause the robot arm to lift the deformable object.

### BRIEF DESCRIPTION OF THE FIGURES

FIG. 1A illustrates a system for performing or facilitating the detection, identification, and retrieval of objects according to embodiments hereof.

FIG. 1B illustrates an embodiment of the system for performing or facilitating the detection, identification, and retrieval of objects according to embodiments hereof.

FIG. 1C illustrates another embodiment of the system for performing or facilitating the detection, identification, and retrieval of objects according to embodiments hereof.

FIG. 1D illustrates yet another embodiment of the system for performing or facilitating the detection, identification, and retrieval of objects according to embodiments hereof.

FIG. 2A is a block diagram that illustrates a computing system configured to perform or facilitate the detection, identification, and retrieval of objects, consistent with embodiments hereof.

FIG. 2B is a block diagram that illustrates an embodiment of a computing system configured to perform or facilitate the detection, identification, and retrieval of objects, consistent with embodiments hereof.

FIG. 2C is a block diagram that illustrates another embodiment of a computing system configured to perform or facilitate the detection, identification, and retrieval of objects, consistent with embodiments hereof.

FIG. 2D is a block diagram that illustrates yet another embodiment of a computing system configured to perform or facilitate the detection, identification, and retrieval of objects, consistent with embodiments hereof.

FIG. 2E is an example of image information processed by systems and consistent with embodiments hereof.

FIG. 2F is another example of image information processed by systems and consistent with embodiments hereof.

FIG. 3A illustrates an exemplary environment for operating a robotic system, according to embodiments hereof.

FIG. 3B illustrates an exemplary environment for the detection, identification, and retrieval of objects by a robotic system, consistent with embodiments hereof.

FIGS. 4A-4D illustrate a sequence of events in a grasping procedure.

FIGS. 5A and 5B illustrate a dual mode gripper.

FIG. 6 illustrates an adjustable multi-point gripping system employing dual mode grippers.

FIGS. 7A-7D illustrate aspects of an adjustable multi-point gripping system.

FIGS. 8A-8D illustrate operation of a dual mode gripper.

FIGS. 9A-9E illustrate aspects of object transport operations involving an adjustable multi-point gripping system

FIG. 10 provides a flow diagram that illustrates a method of grasping a soft object, according to an embodiment herein.

### DETAILED DESCRIPTION

Systems, devices, and methods related to object grasping and gripping are provided. In an embodiment, a dual-mode gripping device is provided. The dual-mode gripping device may be configured to facilitate robotic grasping, gripping, transport, and movement of soft objects. As used herein, soft objects may refer to flexible objects, deformable objects, or partially deformable objects with a flexible outer casing, bagged objects, wrapped objects, and other objects that lack stiff and/or uniform sides. Soft objects may be difficult to grasp, grip, move, or transport due to difficulty in securing the object to a robotic gripper, a tendency to sag, flex, droop, or otherwise change shape when lifted, and/or a tendency to shift and move in unpredictable ways when transported. Such tendencies may result in difficulty in transport, with adverse consequences including dropped and misplaced objects. Although the technologies described herein are specifically discussed with respect to soft objects, the technology is not limited to such. Any suitable object of any shape, size, material, make-up, etc., that may benefit from robotic handling via the systems, devices, and methods discussed herein may be used. Additionally, although some specific references include the term “soft objects,” it may be understood that any objects discussed herein may include or may be soft objects.

In embodiments, a dual mode gripping system or device is provided to facilitate handling of soft object. A dual mode gripping system consistent with embodiments hereof includes at least a pair of integrated gripping devices. The gripping devices may include a suction gripping device and a pinch gripping device. The suction gripping device may be configured to provide an initial or primary grip on the soft object. The pinch gripping device may be configured to provide a supplementary or secondary grip on the soft object.

In embodiments, an adjustable multi-point gripping system is provided. An adjustable multi-point gripping system, as described herein may include a plurality of gripping devices, individually operable, with an adjustable gripping span. The multiple gripping devices may thus provide “multi-point” gripping of an object (such as a soft object). The “gripping span,” or area covered by the multiple gripping devices, may be adjustable, permitting a smaller gripping span for smaller objects, a larger span for larger objects, and/or manipulating objects while being gripped by the multiple gripping devices (e.g., folding an object). Multi-point gripping may be advantageous in providing additional gripping force as well. Spreading out the gripping points through adjustability may provide a more stable grip, as torques at any individual gripping point may be reduced. These advantages may be particularly useful with soft objects, where unpredictable movement may occur during object transport.

Robotic systems configured in accordance with embodiments hereof may autonomously execute integrated tasks by coordinating operations of multiple robots. Robotic systems, as described herein, may include any suitable combination of robotic devices, actuators, sensors, cameras, and computing systems configured to control, issue commands, receive information from robotic devices and sensors, access, analyze, and process data generated by robotic devices, sensors, and camera, generate data or information usable in the control of robotic systems, and plan actions for robotic devices, sensors, and cameras. As used herein, robotic systems are not required to have immediate access or control of robotic actuators, sensors, or other devices. Robotic systems, as described here, may be computational systems configured to improve the performance of such robotic actuators, sensors, and other devices through reception, analysis, and processing of information.

The technology described herein provides technical improvements to a robotic system configured for use in object transport. Technical improvements described herein increase the facility with which specific objects, e.g., soft objects, deformable objects, partially deformable objects and other types of objects, may be manipulated, handled, and/or transported. The robotic systems and computational systems described herein further provide for increased efficiency in motion planning, trajectory planning, and robotic control of systems and devices configured to robotically interact with soft objects. By addressing this technical problem, the technology of robotic interaction with soft objects is improved.

The present application refers to systems and robotic systems. Robotic systems, as discussed herein, may include robotic actuator components (e.g., robotic arms, robotic grippers, etc.), various sensors (e.g., cameras, etc.), and various computing or control systems. As discussed herein, computing systems or control systems may be referred to as “controlling” various robotic components, such as robotic arms, robotic grippers, cameras, etc. Such “control” may refer to direct control of and interaction with the various actuators, sensors, and other functional aspects of the robotic components. For example, a computing system may control a robotic arm by issuing or providing all of the required signals to cause the various motors, actuators, and sensors to cause robotic movement. Such “control” may also refer to the issuance of abstract or indirect commands to a further robotic control system that then translates such commands into the necessary signals for causing robotic movement. For example, a computing system may control a robotic arm by issuing a command describing a trajectory or destination location to which the robotic arm should move to and a further robotic control system associated with the robotic arm may receive and interpret such a command and then provide the necessary direct signals to the various actuators and sensors of the robotic arm to cause the required movement.

In the following, specific details are set forth to provide an understanding of the presently disclosed technology. In embodiments, the techniques introduced here may be practiced without including each specific detail disclosed herein. In other instances, well-known features, such as specific functions or routines, are not described in detail to avoid unnecessarily obscuring the present disclosure. References in this description to “an embodiment,” “one embodiment,” or the like mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics described with respect to any one embodiments can be combined in any suitable manner with those of any other embodiment, unless such items are mutually exclusive. It is to be understood that the various embodiments shown in the figures are merely illustrative representations and are not necessarily drawn to scale.

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments may have different configurations or different components than those described in this section. Accordingly, the disclosed techniques may have other embodiments with additional elements or without several of the elements described below.

Many embodiments or aspects of the present disclosure described below may take the form of computer- or controller-executable instructions, including routines executed by a programmable computer or controller. Those skilled in the relevant art will appreciate that the disclosed techniques can be practiced on or with computer or controller systems other than those shown and described below. The techniques described herein can be embodied in a special-purpose computer or data processor that is specifically programmed, configured, or constructed to execute one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, minicomputers, and the like). Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

Any reference herein to image analysis by a computing system may be performed according to or using spatial structure information that may include depth information which describes respective depth value of various locations relative to a chosen point. The depth information may be used to identify objects or estimate how objects are spatially arranged. In some instances, the spatial structure information may include or may be used to generate a point cloud that describes locations of one or more surfaces of an object. Spatial structure information is merely one form of possible image analysis and other forms known by one skilled in the art may be used in accordance with the methods described herein.

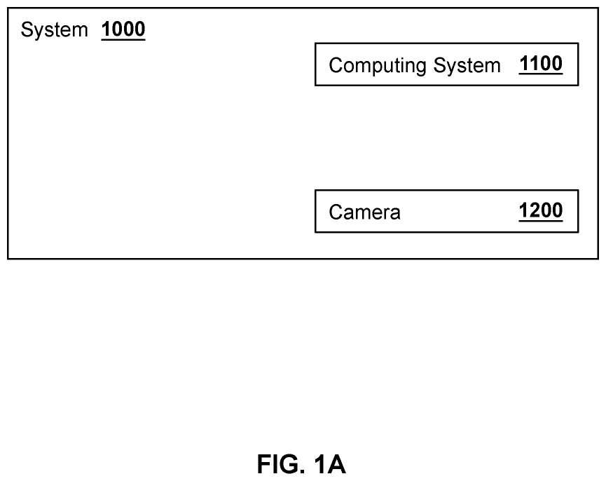

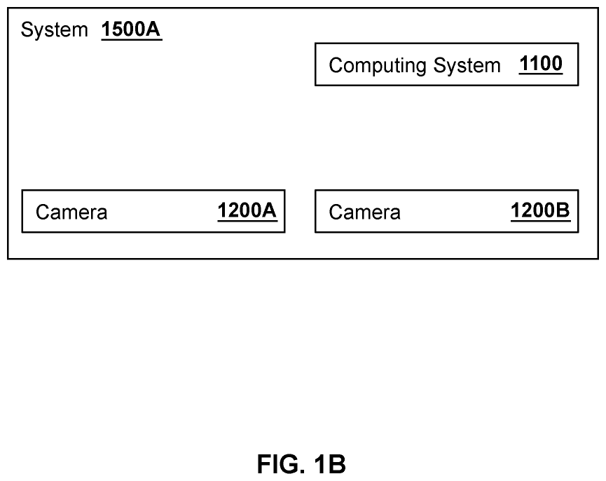

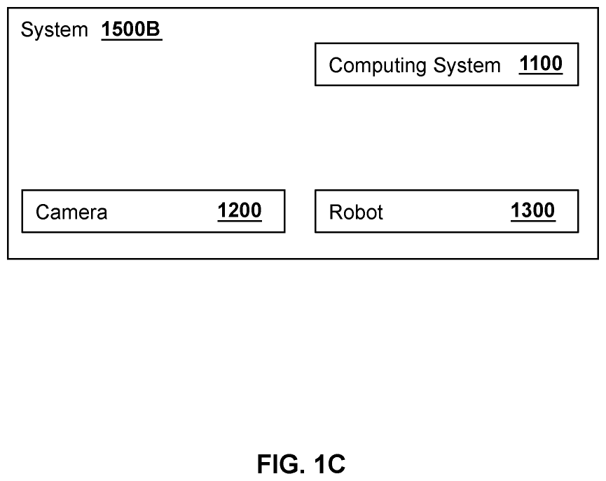

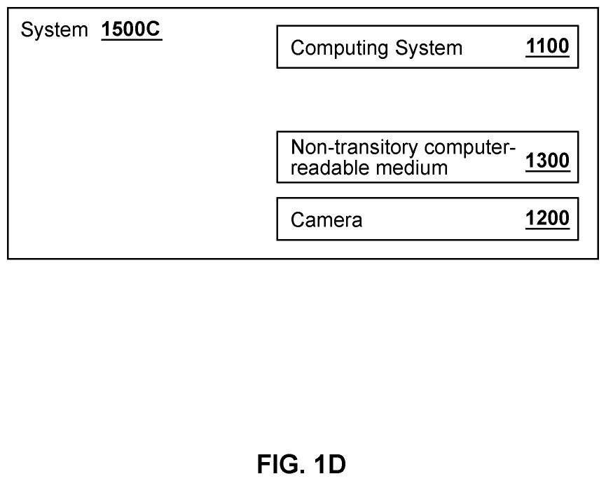

FIG. 1A illustrates a system 1000 for performing object detection, or, more specifically, object recognition. More particularly, the system 1000 may include a computing system 1100 and a camera 1200. In this example, the camera 1200 may be configured to generate image information which describes or otherwise represents an environment in which the camera 1200 is located, or, more specifically, represents an environment in the camera's 1200 field of view (also referred to as a camera field of view). The environment may be, e.g., a warehouse, a manufacturing plant, a retail space, or other premises. In such instances, the image information may represent objects located at such premises, such as bags, boxes, bins, cases, crates, pallets, wrapped objects, other containers, or soft objects. The system 1000 may be configured to generate, receive, and/or process the image information, such as by using the image information to distinguish between individual objects in the camera field of view, to perform object recognition or object registration based on the image information, and/or perform robot interaction planning based on the image information, as discussed below in more detail (the terms “and/or” and “or” are used interchangeably in this disclosure). The robot interaction planning may be used to, e.g., control a robot at the premises to facilitate robot interaction between the robot and the containers or other objects. The computing system 1100 and the camera 1200 may be located at the same premises or may be located remotely from each other. For instance, the computing system 1100 may be part of a cloud computing platform hosted in a data center which is remote from the warehouse or retail space and may be communicating with the camera 1200 via a network connection.

In an embodiment, the camera 1200 (which may also be referred to as an image sensing device) may be a 2D camera and/or a 3D camera. For example, FIG. 1B illustrates a system 1500A (which may be an embodiment of the system 1000) that includes the computing system 1100 as well as a camera 1200A and a camera 1200B, both of which may be an embodiment of the camera 1200. In this example, the camera 1200A may be a 2D camera that is configured to generate 2D image information which includes or forms a 2D image that describes a visual appearance of the environment in the camera's field of view. The camera 1200B may be a 3D camera (also referred to as a spatial structure sensing camera or spatial structure sensing device) that is configured to generate 3D image information which includes or forms spatial structure information regarding an environment in the camera's field of view. The spatial structure information may include depth information (e.g., a depth map) which describes respective depth values of various locations relative to the camera 1200B, such as locations on surfaces of various objects in the camera 1200B's field of view. These locations in the camera's field of view or on an object's surface may also be referred to as physical locations. The depth information in this example may be used to estimate how the objects are spatially arranged in three-dimensional (3D) space. In some instances, the spatial structure information may include or may be used to generate a point cloud that describes locations on one or more surfaces of an object in the camera 1200B's field of view. More specifically, the spatial structure information may describe various locations on a structure of the object (also referred to as an object structure).

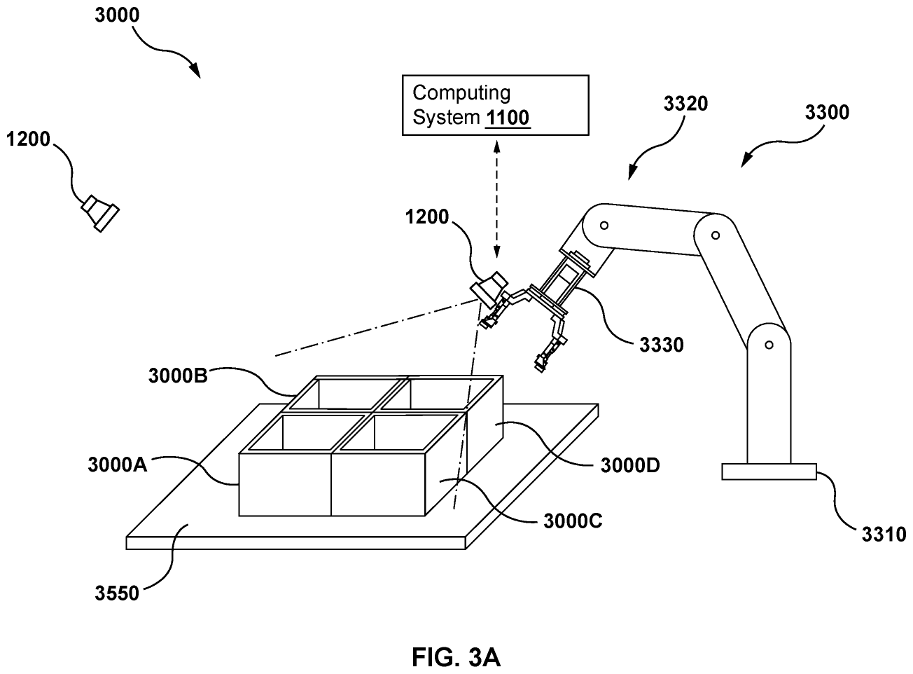

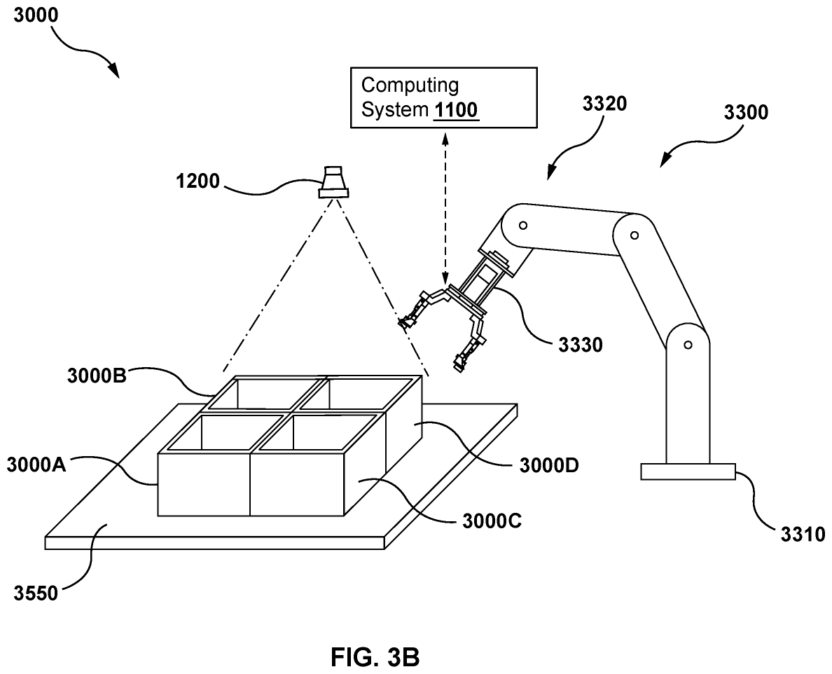

In an embodiment, the system 1000 may be a robot operation system for facilitating robot interaction between a robot and various objects in the environment of the camera 1200. For example, FIG. 1C illustrates a robot operation system 1500B, which may be an embodiment of the system 1000/1500A of FIGS. 1A and 1B. The robot operation system 1500B may include the computing system 1100, the camera 1200, and a robot 1300. As stated above, the robot 1300 may be used to interact with one or more objects in the environment of the camera 1200, such as with bags, boxes, crates, bins, pallets, wrapped objects, other containers, or soft objects. For example, the robot 1300 may be configured to pick up the containers from one location and move them to another location. In some cases, the robot 1300 may be used to perform a de-palletization operation in which a group of containers or other objects are unloaded and moved to, e.g., a conveyor belt. In some implementations, the camera 1200 may be attached to the robot 1300 or the robot 3300, discussed below. This is also known as a camera in-hand or a camera on-hand solution. For instance, as shown in FIG. 3A, the camera 1200 is attached to a robot arm 3320 of the robot 3300. The robot arm 3320 may then move to various picking regions to generate image information regarding those regions. In some implementations, the camera 1200 may be separate from the robot 1300. For instance, the camera 1200 may be mounted to a ceiling of a warehouse or other structure and may remain stationary relative to the structure. In some implementations, multiple cameras 1200 may be used, including multiple cameras 1200 separate from the robot 1300 and/or cameras 1200 separate from the robot 1300 being used in conjunction with in-hand cameras 1200. In some implementations, a camera 1200 or cameras 1200 may be mounted or affixed to a dedicate robotic system separate from the robot 1300 used for object manipulation, such as a robotic arm, gantry, or other automated system configured for camera movement. Throughout the specification, “control” or “controlling” the camera 1200 may be discussed. For camera in-hand solutions, control of the camera 1200 also includes control of the robot 1300 to which the camera 1200 is mounted or attached.

In an embodiment, the computing system 1100 of FIGS. 1A-1C may form or be integrated into the robot 1300, which may also be referred to as a robot controller. A robot control system may be included in the system 1500B, and is configured to e.g., generate commands for the robot 1300, such as a robot interaction movement command for controlling robot interaction between the robot 1300 and a container or other object. In such an embodiment, the computing system 1100 may be configured to generate such commands based on, e.g., image information generated by the camera 1200. For instance, the computing system 1100 may be configured to determine a motion plan based on the image information, wherein the motion plan may be intended for, e.g., gripping or otherwise picking up an object. The computing system 1100 may generate one or more robot interaction movement commands to execute the motion plan.

In an embodiment, the computing system 1100 may form or be part of a vision system. The vision system may be a system which generates, e.g., vision information which describes an environment in which the robot 1300 is located, or, alternatively or in addition to, describes an environment in which the camera 1200 is located. The vision information may include the 3D image information and/or the 2D image information discussed above, or some other image information. In some scenarios, if the computing system 1100 forms a vision system, the vision system may be part of the robot control system discussed above or may be separate from the robot control system. If the vision system is separate from the robot control system, the vision system may be configured to output information describing the environment in which the robot 1300 is located. The information may be outputted to the robot control system, which may receive such information from the vision system and performs motion planning and/or generates robot interaction movement commands based on the information. Further information regarding the vision system is detailed below.

In an embodiment, the computing system 1100 may communicate with the camera 1200 and/or with the robot 1300 via a direct connection, such as a connection provided via a dedicated wired communication interface, such as a RS-232 interface, a universal serial bus (USB) interface, and/or via a local computer bus, such as a peripheral component interconnect (PCI) bus. In an embodiment, the computing system 1100 may communicate with the camera 1200 and/or with the robot 1300 via a network. The network may be any type and/or form of network, such as a personal area network (PAN), a local-area network (LAN), e.g., Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the computing system 1100 may communicate information directly with the camera 1200 and/or with the robot 1300, or may communicate via an intermediate storage device, or more generally an intermediate non-transitory computer-readable medium. For example, FIG. 1D illustrates a system 1500C, which may be an embodiment of the system 1000/1500A/1500B, that includes an intermediate non-transitory computer-readable medium 1400, which may be external to the computing system 1100, and may act as an external buffer or repository for storing, e.g., image information generated by the camera 1200. In such an example, the computing system 1100 may retrieve or otherwise receive the image information from the intermediate non-transitory computer-readable medium 1400. Examples of the intermediate non-transitory computer readable medium 1400 include an electronic storage device, a magnetic storage device, an optical storage device, an electromagnetic storage device, a semiconductor storage device, or any suitable combination thereof. The non-transitory computer-readable medium may form, e.g., a computer diskette, a hard disk drive (HDD), a solid-state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), and/or a memory stick.

As stated above, the camera 1200 may be a 3D camera and/or a 2D camera. The 2D camera may be configured to generate a 2D image, such as a color image or a grayscale image. The 3D camera may be, e.g., a depth-sensing camera, such as a time-of-flight (TOF) camera or a structured light camera, or any other type of 3D camera. In some cases, the 2D camera and/or 3D camera may include an image sensor, such as a charge coupled devices (CCDs) sensor and/or complementary metal oxide semiconductors (CMOS) sensor. In an embodiment, the 3D camera may include lasers, a LIDAR device, an infrared device, a light/dark sensor, a motion sensor, a microwave detector, an ultrasonic detector, a RADAR detector, or any other device configured to capture depth information or other spatial structure information.

As stated above, the image information may be processed by the computing system 1100. In an embodiment, the computing system 1100 may include or be configured as a server (e.g., having one or more server blades, processors, etc.), a personal computer (e.g., a desktop computer, a laptop computer, etc.), a smartphone, a tablet computing device, and/or other any other computing system. In an embodiment, any or all of the functionality of the computing system 1100 may be performed as part of a cloud computing platform. The computing system 1100 may be a single computing device (e.g., a desktop computer), or may include multiple computing devices.

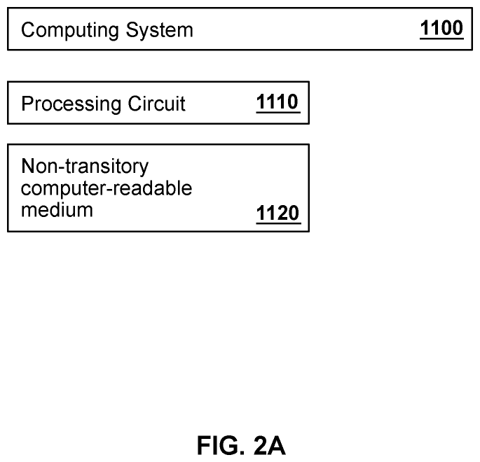

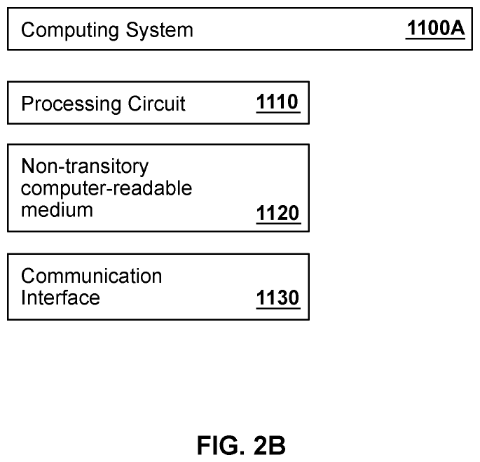

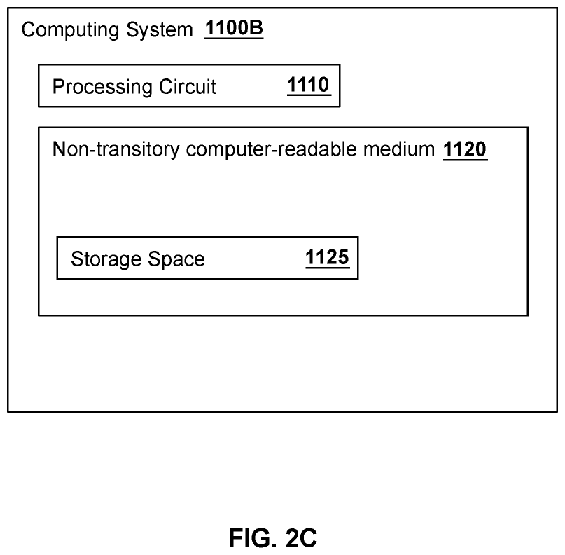

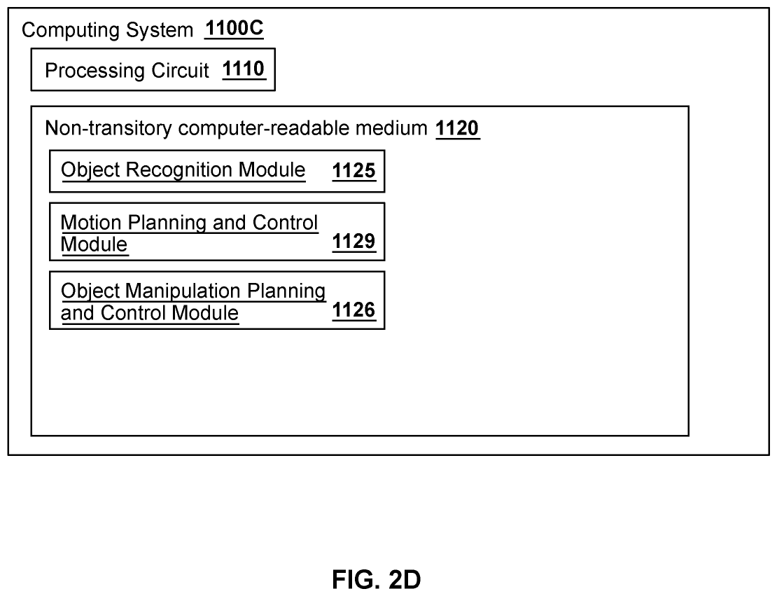

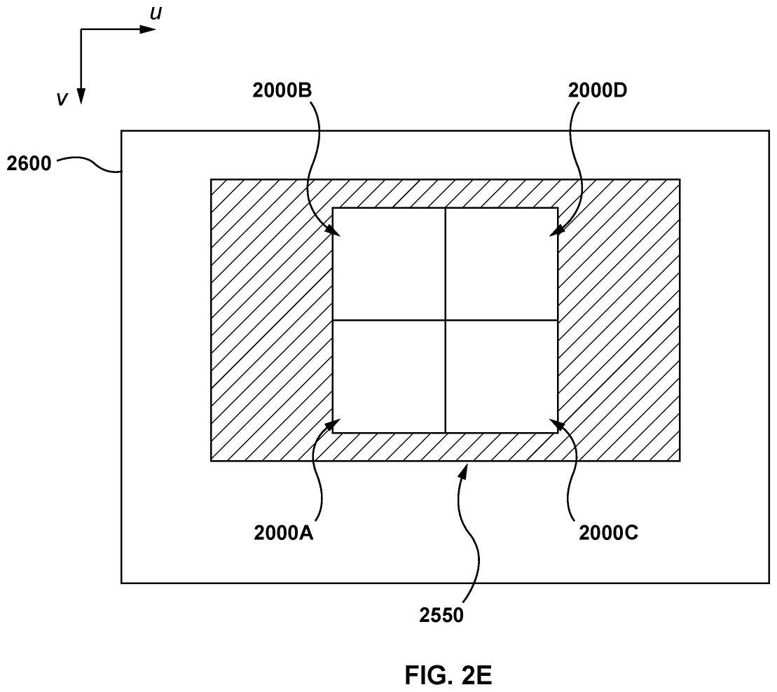

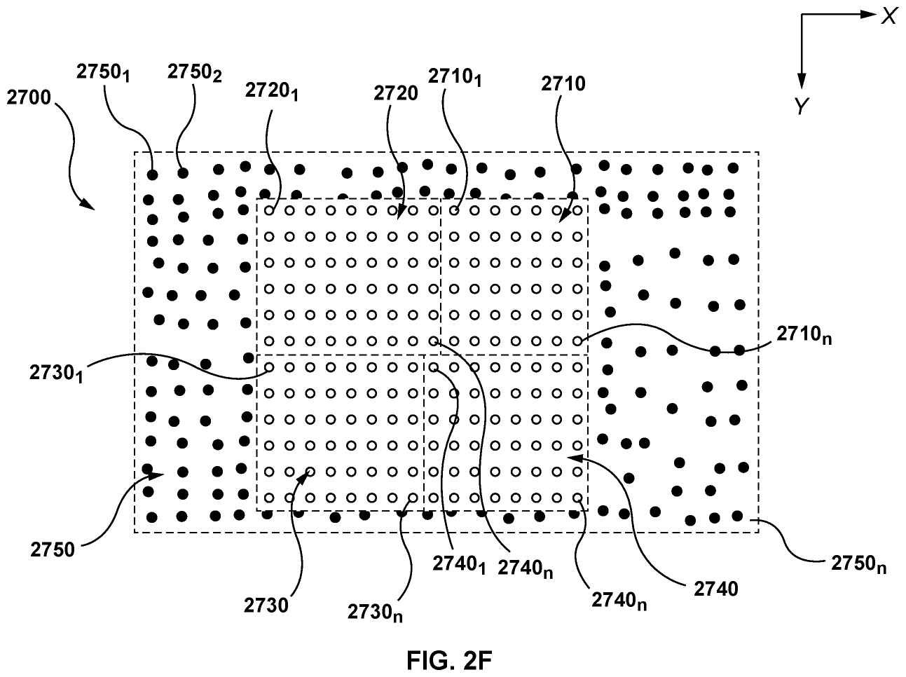

FIG. 2A provides a block diagram that illustrates an embodiment of the computing system 1100. The computing system 1100 in this embodiment includes at least one processing circuit 1110 and a non-transitory computer-readable medium (or media) 1120. In some instances, the processing circuit 1110 may include processors (e.g., central processing units (CPUs), special-purpose computers, and/or onboard servers) configured to execute instructions (e.g., software instructions) stored on the non-transitory computer-readable medium 1120 (e.g., computer memory). In some embodiments, the processors may be included in a separate/stand-alone controller that is operably coupled to the other electronic/electrical devices. The processors may implement the program instructions to control/interface with other devices, thereby causing the computing system 1100 to execute actions, tasks, and/or operations. In an embodiment, the processing circuit 1110 includes one or more processors, one or more processing cores, a programmable logic controller (“PLC”), an application specific integrated circuit (“ASIC”), a programmable gate array (“PGA”), a field programmable gate array (“FPGA”), any combination thereof, or any other processing circuit.

In an embodiment, the non-transitory computer-readable medium 1120, which is part of the computing system 1100, may be an alternative or addition to the intermediate non-transitory computer-readable medium 1400 discussed above. The non-transitory computer-readable medium 1120 may be a storage device, such as an electronic storage device, a magnetic storage device, an optical storage device, an electromagnetic storage device, a semiconductor storage device, or any suitable combination thereof, for example, such as a computer diskette, a hard disk drive (HDD), a solid state drive (SSD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, any combination thereof, or any other storage device. In some instances, the non-transitory computer-readable medium 1120 may include multiple storage devices. In certain implementations, the non-transitory computer-readable medium 1120 is configured to store image information generated by the camera 1200 and received by the computing system 1100. In some instances, the non-transitory computer-readable medium 1120 may store one or more object recognition template used for performing methods and operations discussed herein. The non-transitory computer-readable medium 1120 may alternatively or additionally store computer readable program instructions that, when executed by the processing circuit 1110, causes the processing circuit 1110 to perform one or more methodologies described here.

FIG. 2B depicts a computing system 1100A that is an embodiment of the computing system 1100 and includes a communication interface 1130. The communication interface 1130 may be configured to, e.g., receive image information generated by the camera 1200 of FIGS. 1A-1D. The image information may be received via the intermediate non-transitory computer-readable medium 1400 or the network discussed above, or via a more direct connection between the camera 1200 and the computing system 1100/1100A. In an embodiment, the communication interface 1130 may be configured to communicate with the robot 1300 of FIG. 1C. If the computing system 1100 is external to a robot control system, the communication interface 1130 of the computing system 1100 may be configured to communicate with the robot control system. The communication interface 1130 may also be referred to as a communication component or communication circuit, and may include, e.g., a communication circuit configured to perform communication over a wired or wireless protocol. As an example, the communication circuit may include a RS-232 port controller, a USB controller, an Ethernet controller, a Bluetooth® controller, a PCI bus controller, any other communication circuit, or a combination thereof.

In an embodiment, as depicted in FIG. 2C, the non-transitory computer-readable medium 1120 may include a storage space 1125 configured to store one or more data objects discussed herein. For example, the storage space may store object recognition templates, detection hypotheses, image information, object image information, robotic arm move commands, and any additional data objects the computing systems discussed herein may require access to.

In an embodiment, the processing circuit 1110 may be programmed by one or more computer-readable program instructions stored on the non-transitory computer-readable medium 1120. For example, FIG. 2D illustrates a computing system 1100C, which is an embodiment of the computing system 1100/1100A/1100B, in which the processing circuit 1110 is programmed by one or more modules, including an object recognition module 1121, a motion planning and control module 1129, and an object manipulation planning and control module 1126. Each of the above modules may represent computer-readable program instructions configured to carry out certain tasks when instantiated on one or more of the processors, processing circuits, computing systems, etc., described herein. Each of the above modules may operate in concert with one another to achieve the functionality described herein. Various aspects of the functionality described herein may be carried out by one or more of the software modules described above and the software modules and their descriptions are not to be understood as limiting the computational structure of systems disclosed herein. For example, although a specific task or functionality may be described with respect to a specific module, that task or functionality may also be performed by a different module as required. Further, the system functionality described herein may be performed by a different set of software modules configured with a different breakdown or allotment of functionality.

In an embodiment, the object recognition module 1121 may be configured to obtain and analyze image information as discussed throughout the disclosure. Methods, systems, and techniques discussed herein with respect to image information may use the object recognition module 1121. The object recognition module may further be configured for object recognition tasks related to object identification, as discussed herein.

The motion planning and control module 1129 may be configured plan and execute the movement of a robot. For example, the motion planning and control module 1129 may interact with other modules described herein to plan motion of a robot 3300 for object retrieval operations and for camera placement operations. Methods, systems, and techniques discussed herein with respect to robotic arm movements and trajectories may be performed by the motion planning and control module 1129.

In embodiments, the motion planning and control module 1129 may be configured to plan robotic motion and robotic trajectories to account for the carriage of soft objects. As discussed herein, soft objects may have a tendency to droop, sag, flex, bend, etc. during movement. Such tendencies may be addressed by the motion planning and control module 1129. For example, during lifting operations, it may be expected that a soft object will sag or flex, causing forces on the robotic arm (and associated gripping devices, as described below) to vary, alter, or change in unpredictable ways. Accordingly, the motion planning and control module 1129 may be configured to include control parameters that provide a greater degree of reactivity, permitting the robotic system to adjust to alterations in load more quickly. In another example, soft objects may be expected to swing or flex (e.g., predicted flex behavior) during movement due to internal momentum. Such movements may be adjusted for by the motion planning and control module 1129 by calculating the predicted flex behavior of an object. In yet another example, the motion planning and control module 1129 may be configured to predict or otherwise account for a deformed or altered shape of a transported soft object when the object is deposited at a destination. The flexing or deformation of a soft object (e.g., flex behavior) may result in an object of a different shape, footprint, etc., then that same object had when it was initially lifted. Thus, the motion planning and control module 1129 may be configured to predict or otherwise account for such changes when placing the object down.

The object manipulation planning and control module 1126 may be configured to plan and execute the object manipulation activities of a robotic arm or end effector apparatus, e.g., grasping and releasing objects and executing robotic arm commands to aid and facilitate such grasping and releasing. As discussed below, dual grippers and adjustable multi-point gripping devices may require a series of integrated and coordinated operations to grasp, lift, and transport objects. Such operations may be coordinated by the object manipulation planning and control module 1126 to ensure smooth operation of the dual grippers and adjustable multi-point gripping devices.

With reference to FIGS. 2E, 2F, 3A, and 3B, methods related to the object recognition module 1121 that may be performed for image analysis are explained. FIGS. 2E and 2F illustrate example image information associated with image analysis methods while FIGS. 3A and 3B illustrate example robotic environments associated with image analysis methods. References herein related to image analysis by a computing system may be performed according to or using spatial structure information that may include depth information which describes respective depth value of various locations relative to a chosen point. The depth information may be used to identify objects or estimate how objects are spatially arranged. In some instances, the spatial structure information may include or may be used to generate a point cloud that describes locations of one or more surfaces of an object. Spatial structure information is merely one form of possible image analysis and other forms known by one skilled in the art may be used in accordance with the methods described herein.

In embodiments, the computing system 1100 may obtain image information representing an object in a camera field of view (e.g., field of view 3200) of a camera 1200. The steps and techniques described below for obtaining image information may be referred to below as an image information capture operation 5002. In some instances, the object may be one object from a plurality of objects in the field of view 3200 of a camera 1200. The image information 2600, 2700 may be generated by the camera (e.g., camera 1200) when the objects are (or have been) in the camera field of view 3200 and may describe one or more of the individual objects in the field of view 3200 of a camera 1200. The object appearance describes the appearance of an object from the viewpoint of the camera 1200. If there are multiple objects in the camera field of view, the camera may generate image information that represents the multiple objects or a single object (such image information related to a single object may be referred to as object image information), as necessary. The image information may be generated by the camera (e.g., camera 1200) when the group of objects is (or has been) in the camera field of view, and may include, e.g., 2D image information and/or 3D image information.

As an example, FIG. 2E depicts a first set of image information, or more specifically, 2D image information 2600, which, as stated above, is generated by the camera 1200 and represents the objects 3000A/3000B/3000C/3000D of FIG. 3A situated on the object 3550, which may be, e.g., a pallet on which the objects 3000A/3000B/3000C/3000D are disposed. More specifically, the 2D image information 2600 may be a grayscale or color image and may describe an appearance of the objects 3000A/3000B/3000C/3000D/3550 from a viewpoint of the camera 1200. In an embodiment, the 2D image information 2600 may correspond to a single-color channel (e.g., red, green, or blue color channel) of a color image. If the camera 1200 is disposed above the objects 3000A/3000B/3000C/3000D/3550, then the 2D image information 2600 may represent an appearance of respective top surfaces of the objects 3000A/3000B/3000C/3000D/3550. In the example of FIG. 2E, the 2D image information 2600 may include respective portions 2000A/2000B/2000C/2000D/2550, also referred to as image portions or object image information, that represent respective surfaces of the objects 3000A/3000B/3000C/3000D/3550. In FIG. 2E, each image portion 2000A/2000B/2000C/2000D/2550 of the 2D image information 2600 may be an image region, or more specifically a pixel region (if the image is formed by pixels). Each pixel in the pixel region of the 2D image information 2600 may be characterized as having a position that is described by a set of coordinates [U, V] and may have values that are relative to a camera coordinate system, or some other coordinate system, as shown in FIGS. 2E and 2F. Each of the pixels may also have an intensity value, such as a value between 0 and 255 or 0 and 1023. In further embodiments, each of the pixels may include any additional information associated with pixels in various formats (e.g., hue, saturation, intensity, CMYK, RGB, etc.)

As stated above, the image information may in some embodiments be all or a portion of an image, such as the 2D image information 2600. In examples, the computing system 1100 may be configured to extract an image portion 2000A from the 2D image information 2600 to obtain only the image information associated with a corresponding object 3000A. Where an image portion (such as image portion 2000A) is directed towards a single object it may be referred to as object image information. Object image information is not required to contain information only about an object to which it is directed. For example, the object to which it is directed may be close to, under, over, or otherwise situated in the vicinity of one or more other objects. In such cases, the object image information may include information about the object to which it is directed as well as to one or more neighboring objects. The computing system 1100 may extract the image portion 2000A by performing an image segmentation or other analysis or processing operation based on the 2D image information 2600 and/or 3D image information 2700 illustrated in FIG. 2F. In some implementations, an image segmentation or other processing operation may include detecting image locations at which physical edges of objects appear (e.g., edges of the object) in the 2D image information 2600 and using such image locations to identify object image information that is limited to representing an individual object in a camera field of view (e.g., field of view 3200) and substantially excluding other objects. By “substantially excluding,” it is meant that the image segmentation or other processing techniques are designed and configured to exclude non-target objects from the object image information but that it is understood that errors may be made, noise may be present, and various other factors may result in the inclusion of portions of other objects.

FIG. 2F depicts an example in which the image information is 3D image information 2700. More particularly, the 3D image information 2700 may include, e.g., a depth map or a point cloud that indicates respective depth values of various locations on one or more surfaces (e.g., top surface or other outer surface) of the objects 3000A/3000B/3000C/3000D/3550. In some implementations, an image segmentation operation for extracting image information may involve detecting image locations at which physical edges of objects appear (e.g., edges of a box) in the 3D image information 2700 and using such image locations to identify an image portion (e.g., 2730) that is limited to representing an individual object in a camera field of view (e.g., 3000A).

The respective depth values may be relative to the camera 1200 which generates the 3D image information 2700 or may be relative to some other reference point. In some embodiments, the 3D image information 2700 may include a point cloud which includes respective coordinates for various locations on structures of objects in the camera field of view (e.g., field of view 3200). In the example of FIG. 2F, the point cloud may include respective sets of coordinates that describe the location of the respective surfaces of the objects 3000A/3000B/3000C/3000D/3550. The coordinates may be 3D coordinates, such as [X Y Z] coordinates, and may have values that are relative to a camera coordinate system, or some other coordinate system. For instance, the 3D image information 2700 may include a first image portion 2710, also referred to as an image portion, that indicates respective depth values for a set of locations 2710₁-2710ₙ, which are also referred to as physical locations on a surface of the object 3000D. Further, the 3D image information 2700 may further include a second, a third, a fourth, and a fifth portion 2720, 2730, 2740, and 2750. These portions may then further indicate respective depth values for a set of locations, which may be represented by 2720₁-2720ₙ, 2730₁-2730ₙ, 2740₁-2740ₙ, and 2750₁-2750ₙ respectively. These figures are merely examples, and any number of objects with corresponding image portions may be used. Similar to as stated above, the 3D image information 2700 obtained may in some instances be a portion of a first set of 3D image information 2700 generated by the camera. In the example of FIG. 2E, if the 3D image information 2700 obtained represents an object 3000A of FIG. 3A, then the 3D image information 2700 may be narrowed as to refer to only the image portion 2710. Similar to the discussion of 2D image information 2600, an identified image portion 2710 may pertain to an individual object and may be referred to as object image information. Thus, object image information, as used herein, may include 2D and/or 3D image information.

In an embodiment, an image normalization operation may be performed by the computing system 1100 as part of obtaining the image information. The image normalization operation may involve transforming an image or an image portion generated by the camera 1200, so as to generate a transformed image or transformed image portion. For example, if the image information, which may include the 2D image information 2600, the 3D image information 2700, or a combination of the two, obtained may undergo an image normalization operation to attempt to cause the image information to be altered in viewpoint, object position, lighting condition associated with the visual description information. Such normalizations may be performed to facilitate a more accurate comparison between the image information and model (e.g., template) information. The viewpoint may refer to a pose of an object relative to the camera 1200, and/or an angle at which the camera 1200 is viewing the object when the camera 1200 generates an image representing the object. As used herein, “pose” may refer to an object location and/or orientation.

For example, the image information may be generated during an object recognition operation in which a target object is in the camera field of view 3200. The camera 1200 may generate image information that represents the target object when the target object has a specific pose relative to the camera. For instance, the target object may have a pose which causes its top surface to be perpendicular to an optical axis of the camera 1200. In such an example, the image information generated by the camera 1200 may represent a specific viewpoint, such as a top view of the target object. In some instances, when the camera 1200 is generating the image information during the object recognition operation, the image information may be generated with a particular lighting condition, such as a lighting intensity. In such instances, the image information may represent a particular lighting intensity, lighting color, or other lighting condition.

In an embodiment, the image normalization operation may involve adjusting an image or an image portion of a scene generated by the camera, so as to cause the image or image portion to better match a viewpoint and/or lighting condition associated with information of an object recognition template. The adjustment may involve transforming the image or image portion to generate a transformed image which matches at least one of an object pose or a lighting condition associated with the visual description information of the object recognition template.

The viewpoint adjustment may involve processing, warping, and/or shifting of the image of the scene so that the image represents the same viewpoint as visual description information that may be included within an object recognition template. Processing, for example, may include altering the color, contrast, or lighting of the image, warping of the scene may include changing the size, dimensions, or proportions of the image, and shifting of the image may include changing the position, orientation, or rotation of the image. In an example embodiment, processing, warping, and or/shifting may be used to alter an object in the image of the scene to have an orientation and/or a size which matches or better corresponds to the visual description information of the object recognition template. If the object recognition template describes a head-on view (e.g., top view) of some object, the image of the scene may be warped so as to also represent a head-on view of an object in the scene.

Further aspects of the object recognition and image normalization methods performed herein are described in greater detail in U.S. application Ser. No. 16/991,510, filed Aug. 12, 2020, and U.S. application Ser. No. 16/991,466, filed Aug. 12, 2020, each of which is incorporated herein by reference.

In various embodiments, the terms “computer-readable instructions” and “computer-readable program instructions” are used to describe software instructions or computer code configured to carry out various tasks and operations. In various embodiments, the term “module” refers broadly to a collection of software instructions or code configured to cause the processing circuit 1110 to perform one or more functional tasks. The modules and computer-readable instructions may be described as performing various operations or tasks when a processing circuit or other hardware component is executing the modules or computer-readable instructions.

FIGS. 3A-3B illustrate exemplary environments in which the computer-readable program instructions stored on the non-transitory computer-readable medium 1120 are utilized via the computing system 1100 to increase efficiency of object identification, detection, and retrieval operations and methods. The image information obtained by the computing system 1100 and exemplified in FIG. 3A influences the system's decision-making procedures and command outputs to a robot 3300 present within an object environment.

FIGS. 3A-3B illustrate an example environment in which the process and methods described herein may be performed. FIG. 3A depicts an environment having a robot system 3100 (which may be an embodiment of the system 1000/1500A/1500B/1500C of FIGS. 1A-1D) that includes at least the computing system 1100, a robot 3300, and a camera 1200. The camera 1200 may be an embodiment of the camera 1200 and may be configured to generate image information which represents the camera field of view 3200 of the camera 1200, or more specifically represents objects in the camera field of view 3200, such as objects 3000A, 3000B, 3000C, 3000D and 3550. In one example, each of the objects 3000A-3000D may be, e.g., a soft object or a container such as a box or crate, while the object 3550 may be, e.g., a pallet on which the containers or soft objects are disposed. In embodiments, each of the objects 3000A-3000D may be containers or boxes containing individual soft objects. In embodiments, each of the objects 3000A-3000D may be individual soft objects. Although shown as an organized array, these objects 3000A-3000D may be positioned, arranged, stacked, piled, etc. in any manner atop object 3550. The illustration of FIG. 3A illustrates a camera in-hand setup, while the illustration of FIG. 3B depicts a remotely located camera setup.

In an embodiment, the system 3100 of FIG. 3A may include one or more light sources (not shown). The light source may be, e.g., a light emitting diode (LED), a halogen lamp, or any other light source, and may be configured to emit visible light, infrared radiation, or any other form of light toward surfaces of the objects 3000A-3000D. In some implementations, the computing system 1100 may be configured to communicate with the light source to control when the light source is activated. In other implementations, the light source may operate independently of the computing system 1100.

In an embodiment, the system 3100 may include a camera 1200 or multiple cameras 1200, including a 2D camera that is configured to generate 2D image information 2600 and a 3D camera that is configured to generate 3D image information 2700. The camera 1200 or cameras 1200 may be mounted or affixed to the robot 3300, may be stationary within the environment, and/or may be affixed to a dedicated robotic system separate from the robot 3300 used for object manipulation, such as a robotic arm, gantry, or other automated system configured for camera movement. FIG. 3A shows an example having a stationary camera 1200 and an on-hand camera 1200, while FIG. 3B shows an example having a stationary camera 1200. The 2D image information 2600 (e.g., a color image or a grayscale image) may describe an appearance of one or more objects, such as the objects 3000A/3000B/3000C/3000D/3550 in the camera field of view 3200. For instance, the 2D image information 2600 may capture or otherwise represent visual detail disposed on respective outer surfaces (e.g., top surfaces) of the objects 3000A/3000B/3000C/3000D/3550, and/or contours of those outer surfaces. In an embodiment, the 3D image information 2700 may describe a structure of one or more of the objects 3000A/3000B/3000C/3000D/3550, wherein the structure for an object may also be referred to as an object structure or physical structure for the object. For example, the 3D image information 2700 may include a depth map, or more generally include depth information, which may describe respective depth values of various locations in the camera field of view 3200 relative to the camera 1200 or relative to some other reference point. The locations corresponding to the respective depth values may be locations (also referred to as physical locations) on various surfaces in the camera field of view 3200, such as locations on respective top surfaces of the objects 3000A/3000B/3000C/3000D/3550. In some instances, the 3D image information 2700 may include a point cloud, which may include a plurality of 3D coordinates that describe various locations on one or more outer surfaces of the objects 3000A/3000B/3000C/3000D/3550, or of some other objects in the camera field of view 3200. The point cloud is shown in FIG. 2F.

In the example of FIGS. 3A and 3B, the robot 3300 (which may be an embodiment of the robot 1300) may include a robot arm 3320 having one end attached to a robot base 3310 and having another end that is attached to or is formed by an end effector apparatus 3330, such as a dual-mode gripper and/or adjustable multi-point gripping system, as described below. The robot base 3310 may be used for mounting the robot arm 3320, while the robot arm 3320, or more specifically the end effector apparatus 3330, may be used to interact with one or more objects in an environment of the robot 3300. The interaction (also referred to as robot interaction) may include, e.g., gripping or otherwise picking up at least one of the objects 3000A-3000D. For example, the robot interaction may be part of an object picking operation performed by the object manipulation planning and control module 1126 to identify, detect, and retrieve the objects 3000A-3000D and/or objects located therein.

The robot 3300 may further include additional sensors not shown configured to obtain information used to implement the tasks, such as for manipulating the structural members and/or for transporting the robotic units. The sensors can include devices configured to detect or measure one or more physical properties of the robot 3300 (e.g., a state, a condition, and/or a location of one or more structural members/joints thereof) and/or of a surrounding environment. Some examples of the sensors can include accelerometers, gyroscopes, force sensors, strain gauges, tactile sensors, torque sensors, position encoders, etc.

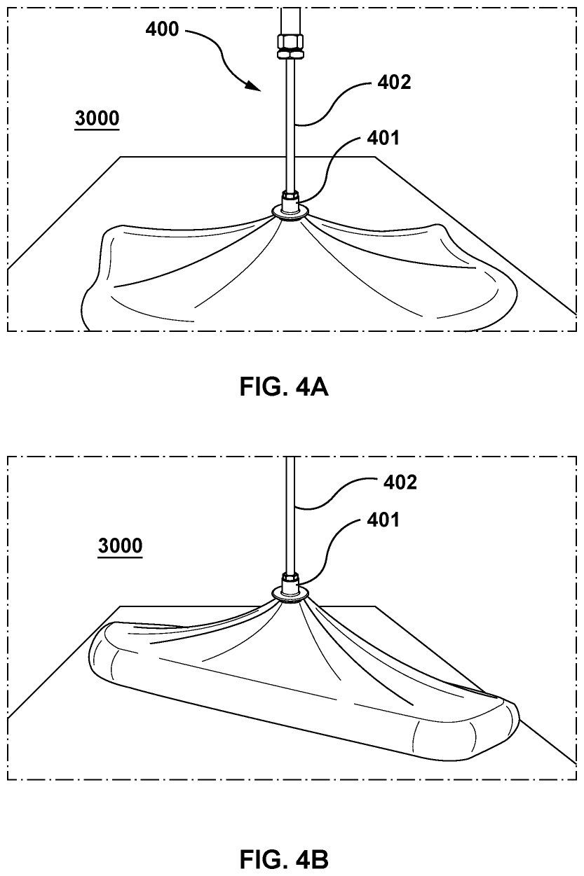

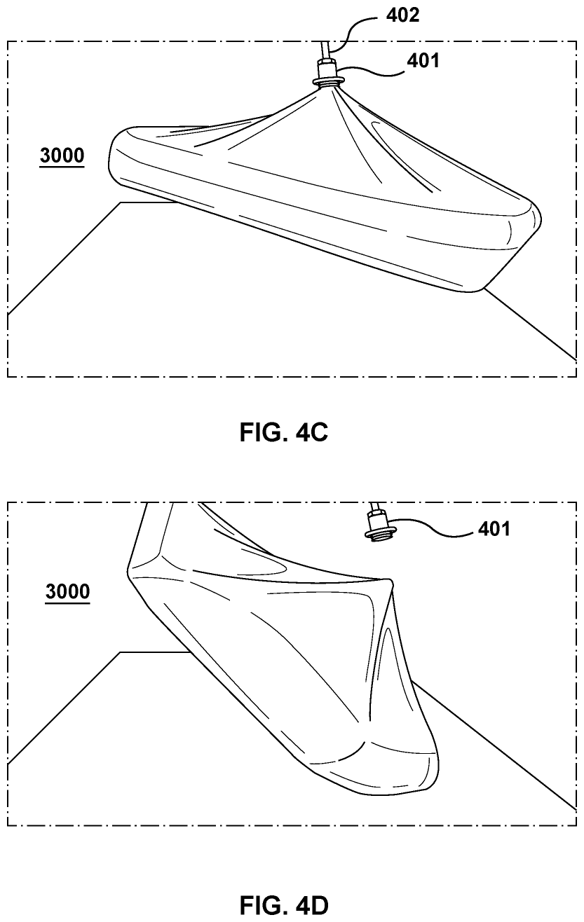

FIGS. 4A-4D illustrate a sequence of events in a grasping procedure performed with a conventional suction head gripper. The conventional suction head gripper 400 includes a suction head 401 and an extension arm 402. The extension arm 402 is controlled to advance the suction head 401 to contact the object 3000. The object 3000 may be a soft, deformable, encased, bagged and/or flexible object. Suction is applied to the object 3000 by the suction head 401, resulting in the establishment of a suction grip, as shown in FIG. 4A. The extension arm 402 retracts, in FIG. 4B, causing the object 3000 to lift. As can be seen in FIG. 4B, the outer casing (e.g., the bag) of object 3000 extends and deforms as the extension arm 402 retracts and the object 3000 hangs at an angle from the suction head 401. This type of unpredictable attitude or behavior of the object 3000 may cause uneven forces on the suction head 401 that may increase the likelihood of a failed grasp. As shown in FIG. 4C, the object 3000 is lifted and transported by the suction head gripper 400. During movement, as shown in FIG. 4D, the object 3000 is inadvertently released from the suction head gripper 400 and falls. The single point of grasping and the lack of reliability of the suction head 401 may contribute to this type of grip/grasp failure.

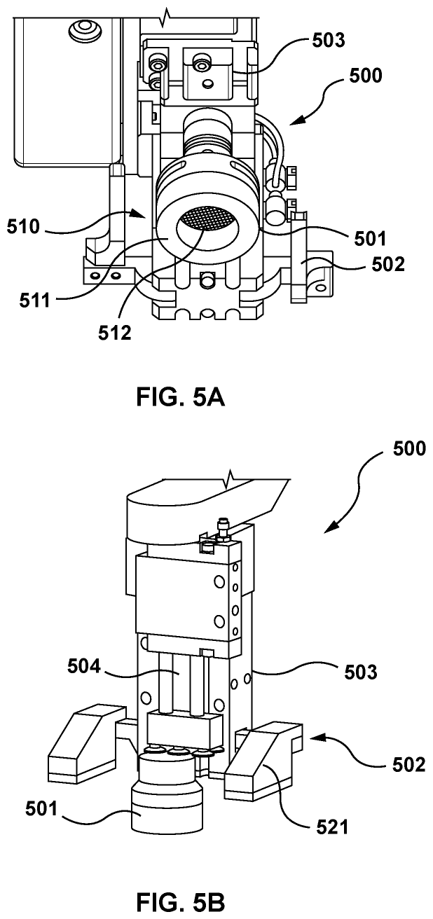

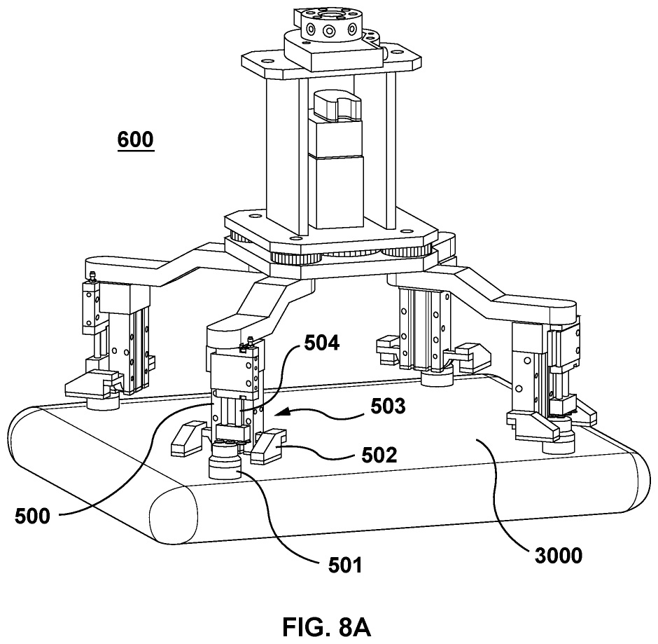

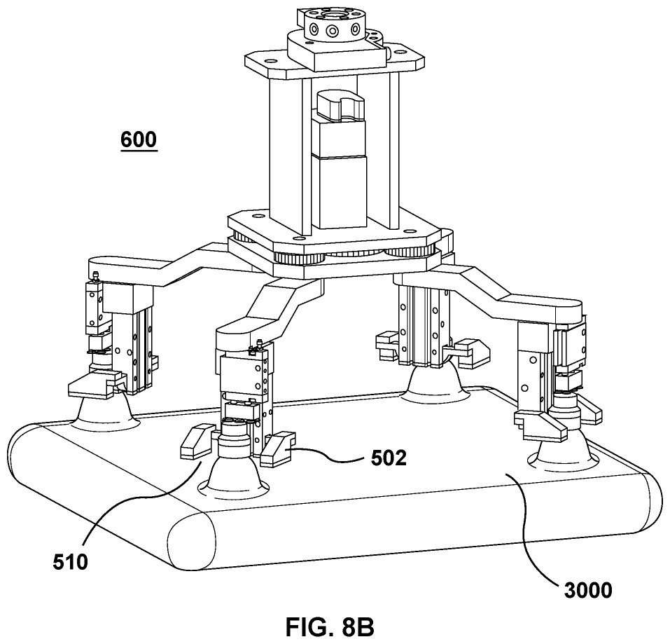

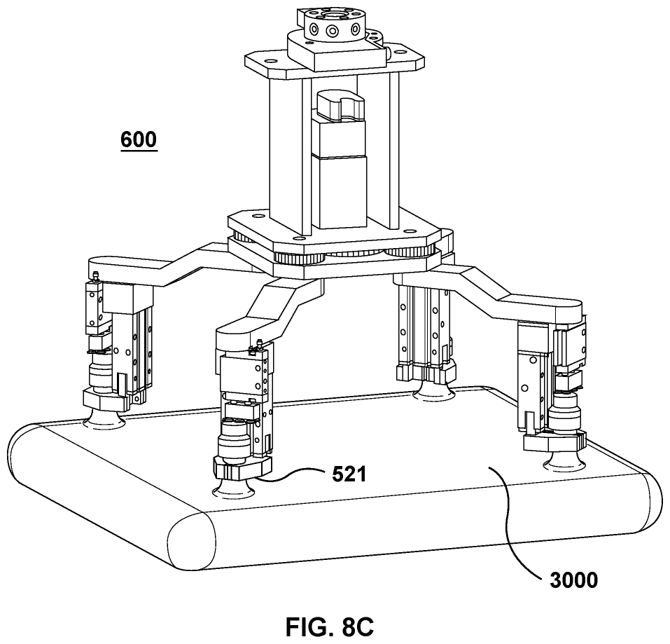

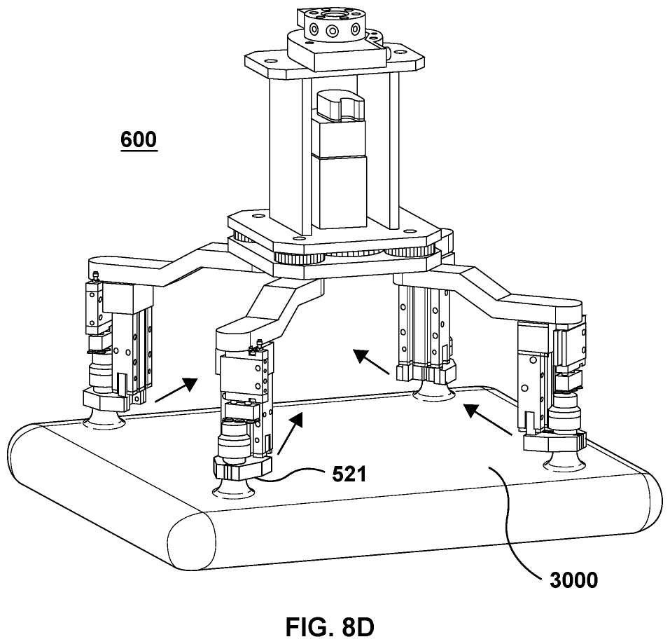

FIGS. 5A and 5B illustrate a dual mode gripper consistent with embodiments hereof. Operation of the dual mode gripper 500 is explained in further detail below with respect to FIGS. 8A-8D. The dual mode gripper 500 may include at least a suction gripping device 501, a pinch gripping device 502, and an actuator arm 503. The suction gripping device 501 and the pinch gripping device 502 may be integrated into the dual mode gripper 500 for synergistic and complementary operation, as described in greater detail below. The dual mode gripper 500 may be mounted to or configured as an end effector apparatus 3330 for attachment to a computer controlled robot arm 3320. The actuator arm 503 may include an extension actuator 504.

The suction gripping device 501 includes a suction head 510 having a suction seal 511 and a suction port 512. The suction seal 511 is configured to contact an object (e.g., a soft object or another type of object) and create a seal between the suction head 510 and the object. When the seal is created, applying suction or low pressure via the suction port 512 generates a grasping or gripping force between the suction head 510 and the object. The suction seal 511 may include a flexible material to facilitate sealing with more rigid objects. In embodiments, the suction seal 511 may also be rigid. Suction or reduced pressure is provided to the suction head 510 via the suction port 512, which may be connected to a suction actuator (e.g., a pump or the like—not shown). The suction gripping device 501 may be mounted to or otherwise attached to the extension actuator 504 of the actuator arm 503. The suction gripping device 501 is configured to provide suction or reduced pressure to grip an object.

The pinch gripping device 502 may include one or more pinch heads 521 and a gripping actuator (not shown), and may be mounted to the actuator arm 503. The pinch gripping device 502 is configured to generate a mechanical gripping force, e.g., a pinch grip on an object via the one or more pinch heads 521. In an embodiment, the gripping actuator causes the one or more pinch heads 521 to come together into a gripping position and provide a gripping force to any object or portion of an object situated therebetween. A gripping position refers to the pinch heads 521 being brought together such that they provide a gripping force on an object or portion of an object that is located between the pinch heads 521 and prevents them from contacting one another. The gripping actuator may cause the pinch heads 521 to rotate into a gripping position, to move laterally (translate) into a gripping position, or perform any combination of translation and rotation to achieve a gripping position.

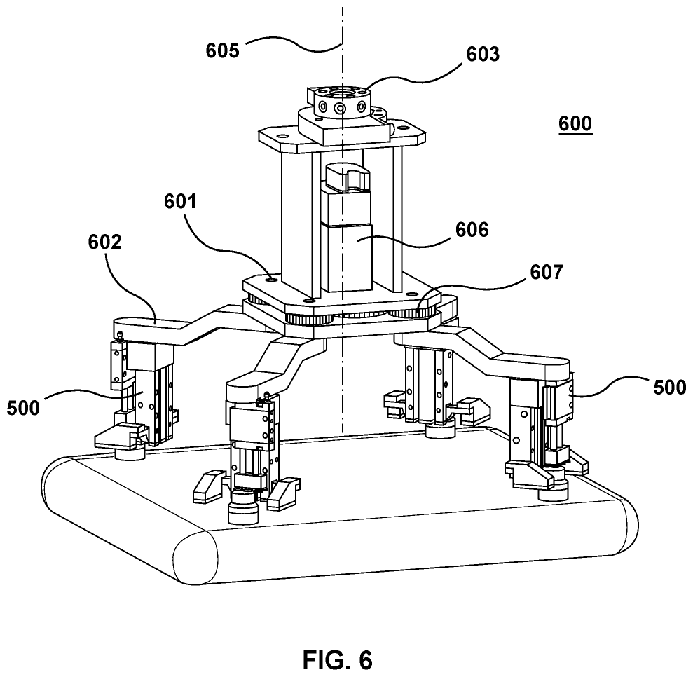

FIG. 6 illustrates an adjustable multi-point gripping system employing dual mode grippers. The adjustable multi-point gripping system 600 (also referred to as a vortex gripper) may be configured as an end effector apparatus 3330 for attachment to a robot arm 3320. The adjustable multi-point gripping system 600 includes at least an actuation hub 601, a plurality of extension arms 602, and a plurality of gripping devices arranged at the ends of the extension arms 602. As illustrated in FIG. 6, the plurality of gripping devices may include dual mode grippers 500, although the adjustable multi-point gripping system 600 is not limited to these, and may include a plurality of any suitable gripping device.

The actuation hub 601 may include one or more actuators 606 that are coupled to the extension arms 602. The extension arms 602 may extend from the actuation hub 601 in at least a partially lateral orientation. As used herein, “lateral” refers to an orientation that is perpendicular to the central axis 605 of the actuation hub 601. By “at least partially lateral” it is meant that the extension arms 602 extend in a lateral orientation but also may extend in a vertical orientation (e.g., parallel to the central axis 605). As shown in FIG. 6, the extension arms 602 extend both laterally and vertically (downward, although upward extension may be included in some embodiments) from the actuation hub 601. The adjustable multi-point gripping system 600 further includes a coupler 603 attached to the actuation hub 601 and configured to provide a mechanical and electrical coupling interface to a robot arm 3320 such that the adjustable multi-point gripping system 600 may operate as an end effector apparatus 3330. In operation, the actuation hub 601 is configured to employ the one or more actuators 606 to rotate the extension arms 602 such that a gripping span (or pitch between gripping devices) is adjusted, as explained in greater detail below. As shown in FIG. 6, the one or more actuators 606 may include a single actuator 606 coupled to a gearing system 607 and configured to drive the rotation of each of the extension arms 602 simultaneously through the gearing system 607.

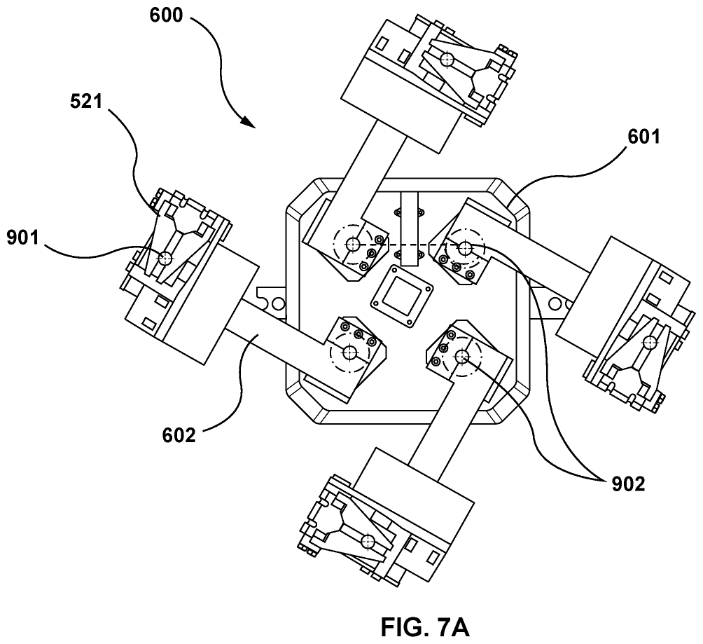

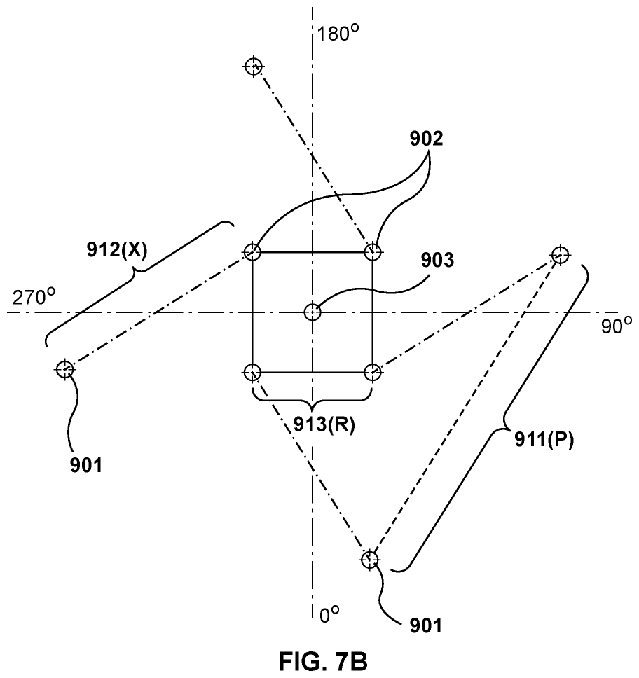

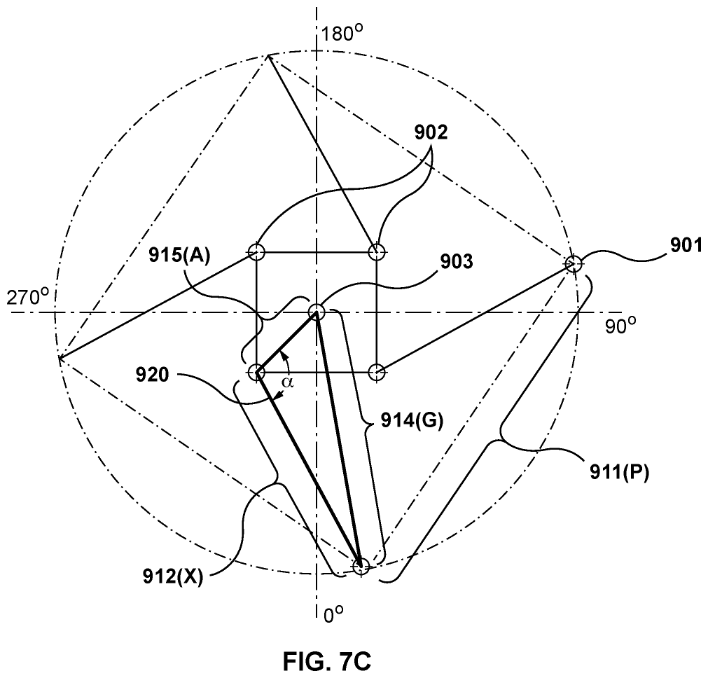

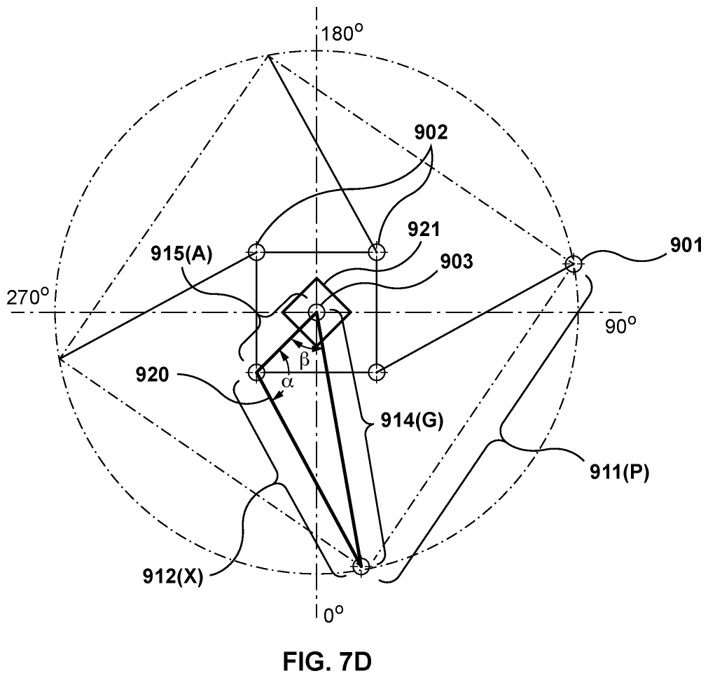

FIGS. 7A-7D illustrate aspects of the adjustable multi-point gripping system 600 (vortex gripper). FIG. 7A illustrates a view of the adjustable multi-point gripping system 600 from underneath. The following aspects of the adjustable multi-point gripping system 600 are illustrated with respect to a system that employs the dual mode grippers 500, but similar principles apply to an adjustable multi-point gripping system 600 employing any suitable object gripping device.

The extension arms 602 extend from the actuation hub 601. The actuation centers 902 of the extension arms 602 are illustrated, as are the gripping centers 901. The actuation centers 902 represent the points about which the extension arms 602 rotate when actuated while the gripping centers 901 represent the centers of the suction gripping devices 501 (or any other gripping device that may be equipped). The suction gripping devices 501 are not shown in FIG. 7A, as they are obscured by the closed pinch heads 521. In operation, the actuator(s) 606 (not shown here) may operate to rotate the extension arms 602 about the actuation centers 902. Such rotation causes the pitch distance between gripping centers 901 to expand and the overall span (i.e., the diameter of the circle on which the gripping centers 901 are located) of the adjustable multi-point gripping system 600 to increase. As shown in FIG. 7A, counter-clockwise rotation of the extension arms 602 increases the pitch distance and span, while clockwise rotation reduces the pitch distance and span. In embodiments, the system may be arranged such that these rotational correspondences are reversed.

FIG. 7B illustrates a schematic view of the adjustable multi-point gripping system 600. The schematic view shows the actuation centers 902, spaced apart by the rotational distances (R) 913. The gripping centers 901 are spaced apart from the actuation centers 902 by the extension distances (X) 912. Physically, the extension distances (X) 912 are achieved by the extension arms 602. The gripping centers 901 are spaced apart from one another by the pitch distances (P) 911. The schematic view also shows the system center 903.

FIG. 7C illustrates a schematic view of the adjustable multi-point gripping system 600 for demonstrating the relationship between the pitch distances (P) 911 and the extension arm angle α. By controlling the extension arm angle α, the system may appropriately establish the pitch distances (P) 911. The schematic view shows a triangle 920 defined by the system center 903, an actuation center 902, and a gripping center 901. The extension distance (X) 912 (between the actuation center and the gripping center 901), the actuation distance (A) 915 (between the system center 903 and the actuation center 902), and the gripping distance (G) 914 (between the system center 903 and the gripping center 901) provide the legs of the triangle 920. The span of the adjustable multi-point gripping system 600 may be defined as twice the gripping distance (G) 914 and may represent the diameter of the circle on which each of the gripping centers 901 are located. The angle α is formed by the actuation distance (A) 915 and the extension distance (X) 912 and represents the extension arm angle at which each extension arm 602 is positioned. The following demonstrates the relationship between the angle α and the pitch distance P. Accordingly, a processing circuit or controller operating the adjustable multi-point gripping system 600 may adjust the angle α to achieve a pitch distance P (e.g., the length of the sides of a square defined by the gripping devices of the adjustable multi-point gripping system 600).

Based on the law of cosines as applied to the triangle 920 defined by the system center 903, the actuation center 902, and the gripping center 901, G²=A²+X²−2AX cos(α). It can be seen that the pitch distance (P) 911 is also the hypotenuse of a right triangle with a right angle at the system center 903. The legs of the right triangle each have a length of the gripping distance (G) 914. Thus, P=\sqrt{2G²}. Accordingly, the relationship between α and P is as follows for values of α between 0 and 180.

P={square root over (2(A²+X²−2AX cos(α)))}

For α=180, the triangle 920 disappears because the extension distance (X) 912 and the actuation distance (A) 915 become collinear. Thus, the pitch distance (P) 911 is based on a right triangle with the pitch distance (P) as hypotenuse—P=\sqrt{2}+(X+A).

FIG. 7D is a schematic illustration demonstrating the relationship between the extension arm angle α and the vortex angle β. By establishing the extension arm angle pα, the system may appropriately establish/understand the vortex angle β and thereby understand how to appropriately orient the adjustable multi-point gripping system 600. The vortex angle β is the angle between the line of the gripping distance (G) 914 and a reference part of the adjustable multi-point gripping system 600. As shown in FIG. 7D, the reference part is a flange 921 of the adjustable multi-point gripping system 600 (also shown in FIGS. 8A). Any feature of the adjustable multi-point gripping system 600 (or the robotic system itself) that maintains its angle relative to the actuation hub 601 may be used as the vortex angle β (and adjusted from the below described dependencies accordingly), so long as the vortex angle ß may be calculated with reference to the extension arm angle α.

Based on the law of sines, the equation

$$\frac{G}{sin α} = \frac{X}{sin β}$$

may be derived. Accordingly,

$$β = arcsin \frac{X sin α}{G} ,$$

where G=\sqrt{A²+X²−2AX cos(α)}. For values of α between 0 and 67.5333°,

$$β = 180 ° - arcsin \frac{X sin α}{G} ,$$

for α=67.5333°, β=90°, for values of α between 67.5333° and 180°,

$$β = arcsine \frac{X sin α}{G} ,$$

and α=180°, β=0

FIGS. 8A-8D illustrate operation of dual mode gripper 500, with further reference to FIG. 5A and FIG. 5B. The dual mode gripper 500 may be operated alone on a robot arm 3320 or end effector apparatus 3330 or, as shown in FIGS. 8A-8D, may be included within an adjustable multi-point gripping system 600. In the embodiment shown in FIGS. 8A-8D, four dual mode grippers 500 are used and mounted at the ends of the extension arms 602 of the adjustable multi-point gripping system 600. Further embodiments may include more or fewer dual mode grippers 500 and/or may include one or more dual mode grippers 500 in operation without the adjustable multi-point gripping system 600.

The dual mode gripper 500 (or multiple dual mode grippers 500) is brought into an engagement position (e.g., a position in a vicinity of an object 3000), as shown in FIG. 8A, by a robot arm 3320 (not shown). When brought into engagement position, dual mode gripper 500 is in a vicinity of the object 3000 sufficient to engage object 3000 via suction gripping device 501 and pinch gripping device 502. In the engagement position, The suction gripping device 501 may then be extended and brought into contact with the object 3000 by action of the extension actuator 504. In embodiments, the suction gripping device 501 may have been previously extended by the extension actuator 504 and may be brought into contact with the object 3000 via action of the robot arm 3320. After contacting the object 3000, the suction gripping device 501 applies suction or low pressure to the object 3000, thereby establishing an initial or primary grip.

The extension actuator 504 is activated to retract the suction gripping device 501 back towards the actuator arm 503, as shown in FIG. 8B. This action causes a portion of the flexible casing (e.g., bag, wrap, etc.) of the object 3000 to extend or stretch away from the remainder of the object 3000. This portion may be referred to as extension portion 3001. The processing circuit or other controller associated with operation of the dual mode gripper 500 and robot arm 3320 may be configured to generate the extension portion(s) 3001 without causing the object 3000 to lift from the surface or other object that it is resting on.

As shown in FIG. 8C, the gripping actuator then causes the pinch heads 521 to rotate and/or translate into the gripping position to apply force to grip the object 3000 at the extension portion(s) 3001. This may be referred to as a secondary or supplemental grip. The mechanical pinch grip provided by the pinch heads 521 provides a secure grip for lifting and/or moving the object 3000. At this point, the suction provided by the suction gripping device 501 may be released and/or may be maintained to provide additional grip security. Optionally, as shown in FIG. 8D, the gripping span (e.g., gripping distance G) may be adjusted to manipulate object 3000 while object 3000 is being gripped by multiple dual mode grippers 500 (e.g., to fold or otherwise bend object 3000).

In embodiments, each dual mode gripper 500 may operate in conjunction with other dual mode grippers 500 or independently from one another when employed in the adjustable multi-point gripping system 600. In the example of FIGS. 8A-8D, each of the dual mode grippers 500 performs the contact, suction, retraction, pinching and/or pitch adjustment operations at approximately the same time. Such concerted movement is not required, and each dual mode gripper 500 may operate independently.

For example, each suction gripping device 501 may be independently extended, retracted, and activated. Each pinch gripping device 501 may be independently activated. Such independent activation may provide advantages in object movement, lifting, folding and transport by providing different numbers of contact points. This may be advantageous when objects have different or odd shapes, when objects that are flexible are folded, flexed, or otherwise distorted into non-standard shapes, and/or when object size constraints are taken into account. For example, it may be more advantageous to grip an object with three spaced apart dual mode grippers 500 (where a fourth could not find purchase on the object) relative to reducing the span of the adjustable multi-point gripping system 600 to achieve four gripping points. Additionally, the independent operation may assist in lifting procedures. For example, lifting multiple gripping points at different rates may increase stability, particularly when a force provided by an object on one gripping point is greater than that provided on another.

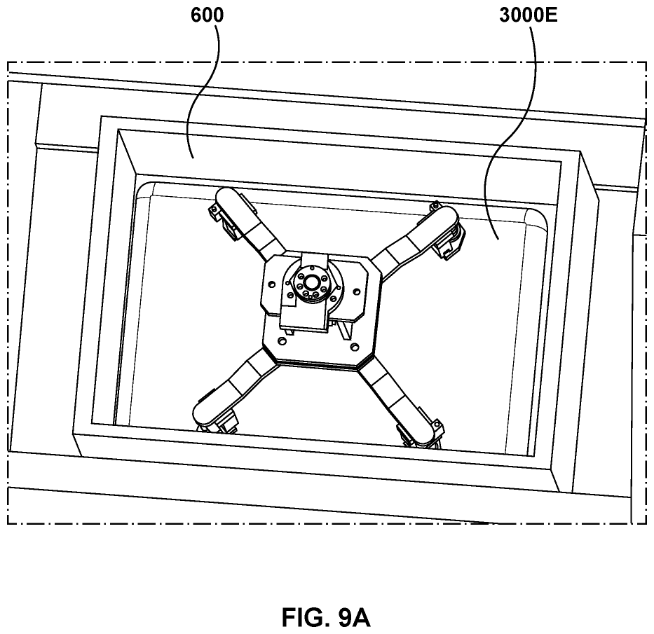

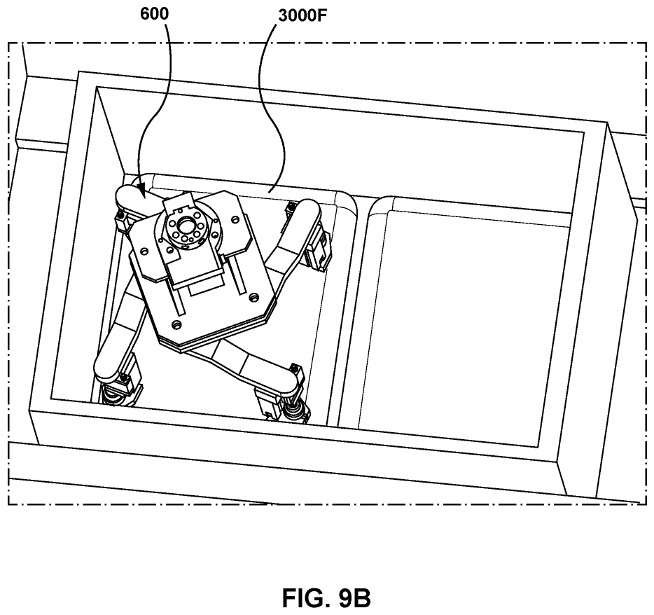

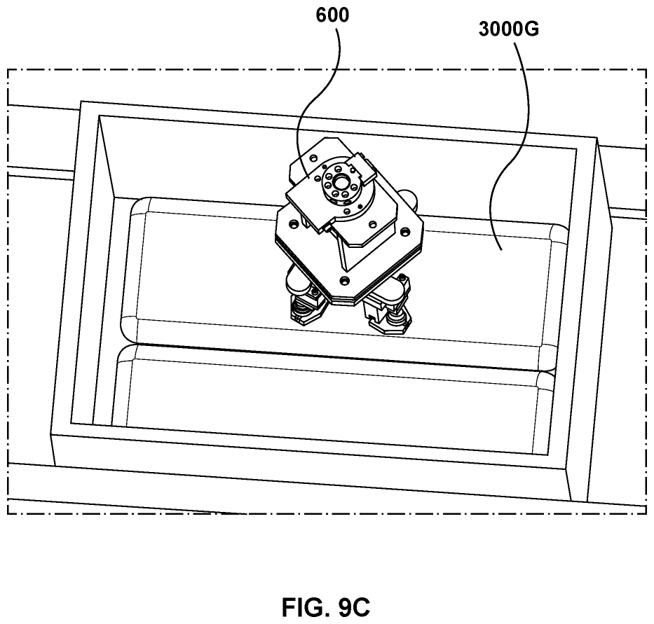

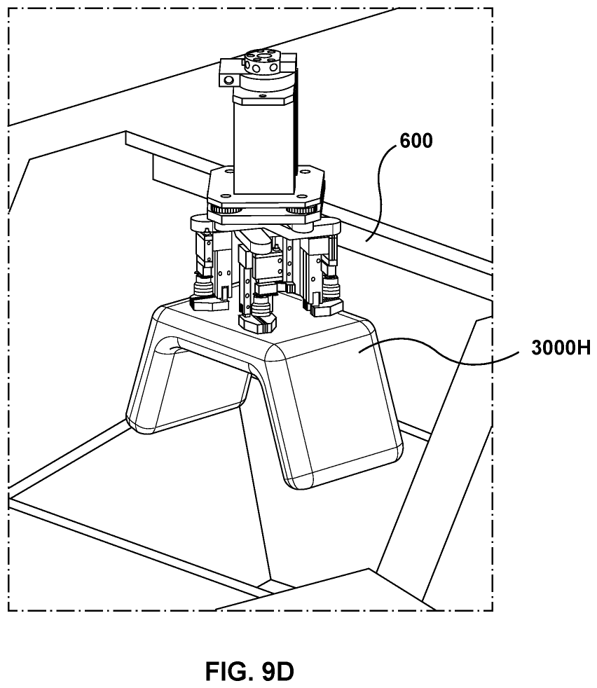

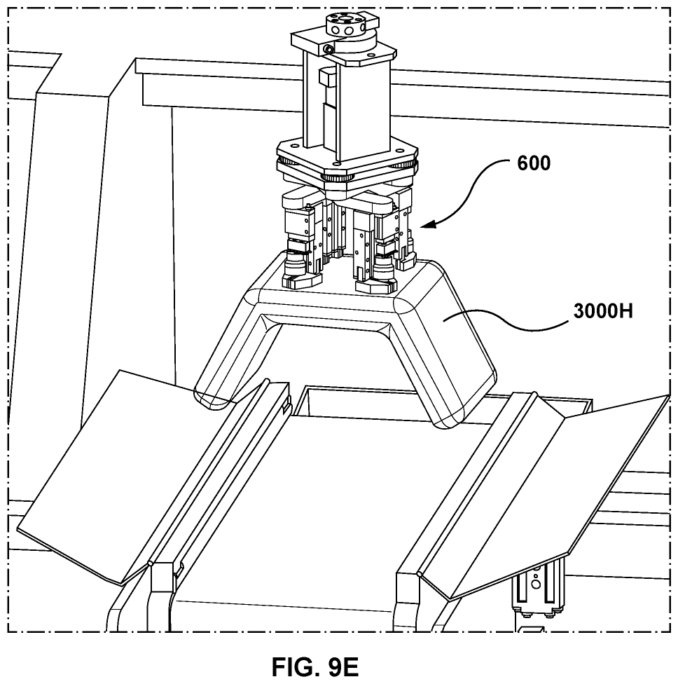

FIGS. 9A-9E illustrate operation of a system including both the vortex end effector apparatus and a dual mode gripper. FIG. 9A illustrates the adjustable multi-point gripping system 600 being used to grip an object 3000E. FIG. 9B illustrates the adjustable multi-point gripping system 600 having a reduced gripping span being used to grip an object 3000F, smaller than object 3000E. FIG. 9C illustrates the adjustable multi-point gripping system 600 having a reduced gripping span being used to grip an object 3000G, which is smaller than both object 3000E and object 3000F. As shown in the sequence of FIGS. 9A-9C, the adjustable multi-point gripping system 600 is versatile and may be used for gripping soft objects of varying sizes. As previously discussed, it may be advantageous to grip soft objects closer to their edges to aid in the predictability of transfer. The adjustability of the adjustable multi-point gripping system 600 permits grips close to the edges of soft objects of varying sizes. FIGS. 9D and 9E illustrate the grasping, lifting, and movement of an object 3000H by the adjustable multi-point gripping system 600. As shown in FIGS. 9D and 9E, the rectangularly shaped object 3000H deforms on either end of the portion that is gripped. The adjustable multi-point gripping system 600 may be configured to grip a soft object to achieve optimal placement when transporting. For example, by selecting a smaller gripping span, the adjustable multi-point gripping system 600 may induce deformation on either side of the gripped portion. In further embodiments, reducing the gripping span while an object is grip may cause a desired deformation.

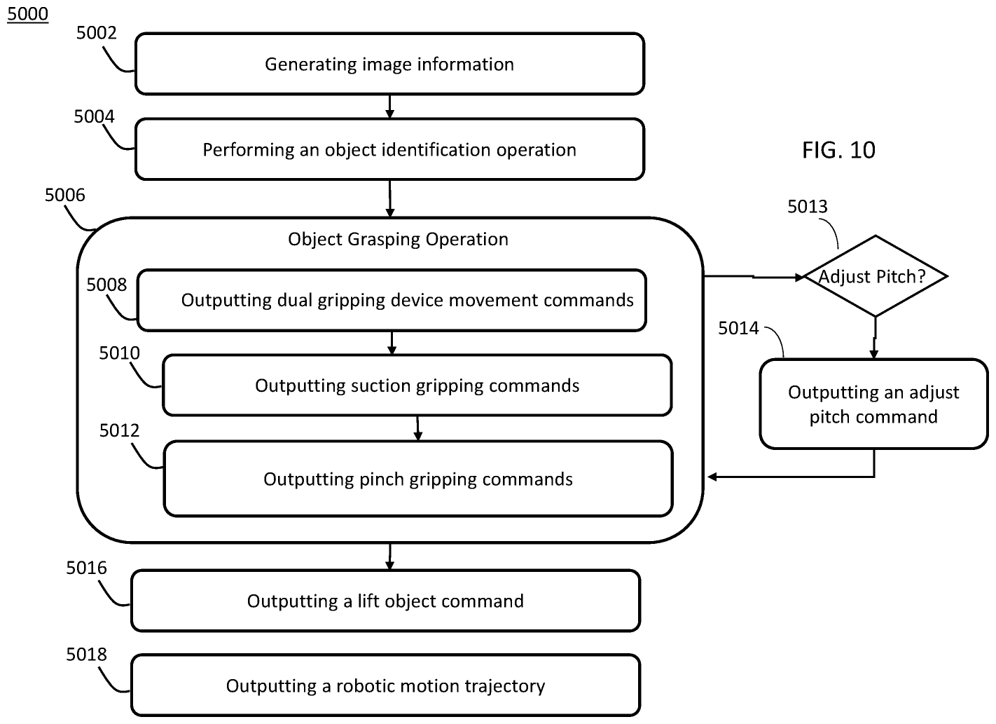

The present disclosure relates further to grasping flexible, wrapped, or bagged objects. FIG. 10 depicts a flow diagram for an example method 5000 for grasping flexible, wrapped, or bagged objects.

In an embodiment, the method 5000 may be performed by, e.g., the computing system 1100 of FIGS. 2A-2D, or more specifically by the at least one processing circuit 1110 of the computing system 1100. In some scenarios, the at least one processing circuit 1110 may perform the method 5000 by executing instructions stored on a non-transitory computer-readable medium (e.g., 1120). For instance, the instructions may cause the processing circuit 1110 to execute one or more of the modules illustrated in FIG. 2D, which may perform the method 5000. For example, in embodiments, steps related to object placement, grasping, lifting and handling, e.g., operations 5006, 5008, 5010, 5012, 5013, 5014, 5016, and others, may be performed by object manipulation planning module 1126. For example, in embodiments, steps related to motion and trajectory planning of the robot arm 3320, e.g., operation 5008 and 5016, and others, may be performed by a motion planning module 1129. In some embodiments, the object manipulation planning module 1126 and the motion planning module 1129 may operate in concert to define and/or plan grasping and/or moving soft objects that involve both motion and object manipulation.

The steps of the method 5000 may be used to achieve specific sequential robot movements for performing specific tasks. As a general overview, the method 5000 may operate to cause the robot 3300 to grasp soft objects. Such an object manipulation operation may further include operation of the robot 3300 that is updated and/or refined according to various operations and conditions (e.g., unpredictable soft object behavior) during the operation.

The method 5000 may begin with or otherwise include an operation 5002, in which the computing system (or processing circuit thereof) is configured to generate image information (e.g., 2D image information 2600 shown in FIG. 2E or 3D image information 2700 shown in FIG. 2700) describing a deformable object to be grasped. As discussed above, the image information is generated or captured by at least one camera (e.g., cameras 1200 shown in FIG. 3A or camera 1200 shown in 3B) and may include commands to a robot arm (e.g., robot arm 3320 shown in FIGS. 3A and 3B) to move to a position in which the camera (or cameras) can image the deformable object to be grasped. Generating the image information may further include any of the above described methods or techniques related to object recognition, e.g., with respect to the generation of spatial structural information (point clouds) of the imaged repositories.

In an embodiment, the method 5000 includes object identification operation 5004, in which the computing system performs an object identification operation. The object identification operation may be performed based on the image information. As discussed above, the image information is obtained by the computing system 1100 and may include all or at least a portion of a camera's field of view (e.g., camera's field of view 3200 shown in FIGS. 3A and 3B). According to embodiments, computing system 1100 then operates to analyze or process the image information to identify one or more objects to manipulate (e.g., grasp, pick up, fold, etc.).

The computing system (e.g., computing system 1100) may use the image information to more precisely determine a physical structure of the object to be grasped. The structure may be determined directly from the image information, and/or may be determined by comparing the image information generated by the camera against, e.g., model repository templates and/or model object templates.

The object identification operation 5004 may include additional optional steps/and or operations (e.g., template matching operations where features identified in the image information are matched by the processing circuit 1110 against a template of a target object stored in the non-transitory computer-readable medium 1120) to improve system performance. Further aspects of the optional template matching operations are described in greater detail in U.S. application Ser. No. 17/733,024, filed Apr. 29, 2022, which is incorporated herein by reference.

In embodiments, the object identification operation 5004 may compensate for image noise by inferring missing image information. For example, if the computing system (e.g., computing system 1100) is using a 2D image or a point cloud that represents a repository, the 2D image or point cloud may have one or more missing portions due to noise. The object identification operation 5004 may be configured to infer the missing info by closing or filling in the gap, for example, by interpolation or other means.

As described above, the object identification operation 5004 may be used to refine the computing system understanding of a geometry of the deformable object to be grasped, which may be used to guide the robot. For example, as shown in FIGS. 7A-7D, the processing circuit 1110 may calculate a position to engage the deformable object (i.e., engagement position) for grasping. According to embodiments, the engagement position may include an engagement position for an individual dual mode gripper 500 or may include an engagement position for each dual mode gripper 500 coupled to the multi-point gripping system 600. In an embodiment, the object identification operation 5004 may calculate actuator commands for the actuation centers (e.g., actuation centers 902) that actuate the dual mode grippers (e.g., dual mode gripper 500) according to the methods shown in FIGS. 7B-7D and described above. For example, the different object manipulation scenarios described above and shown in FIGS. 9A-9E require different actuator commands to actuate different engagement positions for dual mode grippers 500 according to objects 3000E-3000H.

In an embodiment, the method 5000 includes the object grasping operation 5006, in which the computing system (e.g., computing system 1100) outputs an object grasping command. The object grasping command causes the end effector apparatus (e.g., end effector apparatus 3330) of the robot arm (e.g., robot arm 3320) to grasp an object to be picked up (e.g., object 3000, which may be a soft, deformable, encased, bagged and/or flexible object).

According to an embodiment, the object grasping command includes a multi-point gripping system movement operation 5008. According to embodiments described herein, the multi-point gripping system 600 coupled to the end effector apparatus 3330 is moved to the engagement position to pick up the object in accordance with the output of movement commands. In some embodiments, all of the dual mode grippers 500 are moved to According to other embodiments, less than all of the dual mode grippers 500 coupled to the end effector apparatus 3330 are moved to the engagement position to pick up the object (e.g., due to the size of the object, due to the size of a container storing the object, to pick up multiple objects in one container, etc.). In addition, according to one embodiment, the object grasping operation 5006 outputs commands that instruct the end effector apparatus (e.g., end effector apparatus 3330) to pick up multiple objects (e.g., at least one soft object per dual mode gripper coupled to end effector apparatus). While not shown in FIG. 10, further commands in addition to actuator commands for the actuation centers 902 described above may be executed to move each dual mode gripper 500 to the engagement position 700. For example, actuation commands for the robot arm 3320 may be executed by the motion planning module 1129 prior to or synchronous with actuator commands for the actuation centers 902

In an embodiment, the object grasping operation 5006 of the method 5000 includes a suction gripping command operation 5010 and a pinch gripping command operation 5012. According to the embodiment shown in FIG. 10, the object grasping operation 5006 includes at least one set of suction gripping command operations 5010 and one set of pinch gripping command operations 5012 for each dual gripping device (e.g., dual gripping device 500) coupled to end effector apparatus (e.g., end effector apparatus 3330) of the robot arm (e.g., robot arm 3320). For example, according to embodiments, the end effector apparatus 3330 of the robot arm 3320 includes a single dual mode gripper 500 and one set of each of suction gripping command operations 5010 and pinch gripping command operations 5012 are outputted for execution by processing circuit 1110. According to other embodiments, the end effector apparatus 3330 of the robot arm 3320 includes a multiple dual mode gripper 500 (e.g. multi-point gripping system 600) and up to a corresponding number of suction gripping command operation 5010 and pinch gripping command operation 5012 sets—corresponding to each dual mode gripper 500 designated to be engaged according to the object pickup operation 5006—are outputted for execution by processing circuit 1110.

In an embodiment, the method 5000 includes suction gripping command operation 5010, in which the computing system (e.g., computing system 1100) outputs suction gripping commands. According to embodiments, the suction gripping command causes a suction gripping device (e.g., suction gripping device 501) to grip or otherwise grasp an object via suction, as described above. The suction gripping command may be executed during execution of the object grasping operation when the robot arm (e.g., robot arm 3320) is in position to pick up or grasp an object (e.g., object 3000). Moreover, the suction gripping command may be calculated based on the object identification operation (e.g., calculation performed based on an understanding of a geometry of the deformable object).

In an embodiment, the method 5000 includes pinch gripping command operation 5012, in which the computing system (e.g., computing system 1100) outputs pinch gripping commands. According to embodiments, the pinch gripping command causes a pinch gripping device (e.g., pinch gripping device 502) to grip or otherwise grasp the object 3000 via a mechanical gripping force, as described above. The pinch gripping command may be executed during the object grasping operation and the robot arm (e.g., robot arm 3320) is in position to pick up or grasp an object (e.g., object 3000). Moreover, the pinch gripping command may be calculated based on the object identification operation (e.g., calculation performed based on an understanding of a geometry of the deformable object).

In embodiments, the method 5000 may include pitch adjustment determination operation 5013, in which the computing system (e.g., computing system 1100) optionally determines whether to output an adjust pitch command. Furthermore, in embodiments, the method 5000 includes pitch adjustment operation 5014, in which the computing system, based on the pitch adjustment determination of operation 5013 to optionally output a pitch adjustment command. According to embodiments, the adjust pitch command causes an actuation hub (e.g., actuation hub 601) coupled to the end effector apparatus (e.g., end effector apparatus 3330) to actuate one or more actuators (e.g., actuators 606) to rotate the extension arms 602 such that a gripping span (or pitch between gripping devices) is adjusted (e.g., reduced or enlarged), as described above. The adjust pitch command may be executed during execution of the object grasping operation and the robot arm (e.g., robot arm 3320) is in position to pick up or grasp an object (e.g., object 3000). Moreover, the adjust pitch command may be calculated based on the object identification operation (e.g., calculation performed based on an understanding of a geometry or behavior of the deformable object). In embodiments, the pitch adjustment operation 5014 may be configured to occur after of before any of the object grasping operation 5006 sub-operations. For example, the pitch adjustment operation 5014 may occur before or after the multi-point gripping system movement operation 5008, before or after the suction gripping command operation 5010, and/or before or after the pinch gripping command operation 5012. In some scenarios, the pitch may be adjusted while the object is grasped (as discussed above). In some scenarios, the object may be released after grasping to adjust the pitch before re-grasping. In some scenarios, the multi-point gripping system 600 may have its position adjusted after a pitch adjustment.

In an embodiment, the method 5000 includes outputting a lift object command operation 5016, in which the computing system (e.g., computing system 1100) outputs a lift object command. According to embodiments, the lift object command causes a robot arm (e.g., robot arm 3320) to lift an object (e.g., object 3000) from the surface or other object (e.g., object 3550) that it is resting on (e.g., a container for transporting one or more soft objects) and thereby allow the object to be moved freely, as described above. The lift object command may be executed after the object grasping operation 5006 is executed and the dual mode gripping system 600 has gripped the object. Moreover, the lift object command may be calculated based on the object identification operation 5004 (e.g., calculation performed based on an understanding of a geometry or behavior of the deformable object).

Subsequent to the lift object command operation 5016, a robotic motion trajectory operation 5018 may be carried out. During the robotic motion trajectory operation 5018, the robotic system and robotic arm may receive commands from the computer system (e.g., computing system 1100) to execute a robotic motion trajectory and an object placement command. Accordingly, the robotic motion trajectory operation 5018 may be executed to cause movement and placement of the grasped/lifted object.

It will be apparent to one of ordinary skill in the relevant arts that other suitable modifications and adaptations to the methods and applications described herein can be made without departing from the scope of any of the embodiments. The embodiments described above are illustrative examples and it should not be construed that the present disclosure is limited to these particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single component, module, or unit for purposes of clarity, it should be understood that the features and functions described herein may be performed by any combination of components, units, or modules. Thus, various changes and modifications may be affected by one skilled in the art without departing from the spirit or scope of the invention.

Further embodiments are included in the following numbered paragraphs.

Embodiment 1 is a robotic grasping system comprising: an actuator arm; a suction gripping device connected to the actuator arm; and a pinch gripping device connected to the actuator arm.

Embodiment 2 the robotic grasping system of embodiment 1, wherein: the suction gripping device is configured to apply suction to grip an object.

Embodiment 3 is the robotic grasping system of any of embodiments 1-2, wherein: the pinch gripping device is configured to apply a mechanical force to grip an object.

Embodiment 4 is the robotic grasping system of any of embodiments 1-3, wherein the suction gripping device and the pinch gripping device are integrated together as a dual-mode gripper extending from the actuator arm.

Embodiment 5 is the robotic grasping system of embodiment 4, wherein the suction gripping device is configured to apply suction to an object to provide an initial grip and the pinch gripping device is configured to apply a mechanical force to the object to provide a secondary grip.

Embodiment 6 is the robotic grasping system of embodiment 5, wherein the pinch gripping device is configured to apply the mechanical force at a location on the object gripped by the suction gripping device.

Embodiment 7 is the robotic grasping system of embodiment 6, wherein the suction gripping device is configured to apply the initial grip to a flexible object to raise a portion of the flexible object and the pinch gripping device is configured to apply the secondary grip by pinching the portion.

Embodiment 8 is the robotic grasping system of embodiment 7, wherein the suction gripping device includes an extension actuator configured to extend a suction head of the suction gripping device to make contact with the flexible object and retract the suction head of the suction gripping device to bring the portion of the flexible object into a gripping range of the pinch grip device.

Embodiment 9 is the robotic grasping system of any of embodiments 1-8, further comprising a plurality of additional actuator arms, each additional actuator arm including a suction gripping device and a pinch gripping device.

Embodiment 10 is the robotic grasping system of any of embodiments 1-9, further comprising a coupler configured to permit the robotic grasping system to be attached to a robotic system as an end effector apparatus.

Embodiment 11 is a robotic grasping system comprising: an actuator hub; a plurality of extension arms extending from the robotic hub in an at least a partially lateral orientation; and a plurality of gripping devices arranged at ends of the plurality of extension arms.

Embodiment 12 is the robotic grasping system of embodiment 11, wherein each of the plurality of gripping devices includes: a suction gripping device; and a pinch gripping device.

Embodiment 13 is the robotic grasping system of any of embodiments 11-12, wherein: the actuator hub includes one or more actuators coupled to the extension arms, the one or more actuators being configured to rotate the plurality of extension arms such that a gripping span of the plurality of gripping devices is adjusted.

Embodiment 14 is the robotic grasping system of embodiment 13, further comprising: at least one processing circuit configured to adjust the gripping span of the plurality of gripping devices by at least one of: causing the one or more actuators to increase the gripping span of the plurality of gripping devices; and causing the one or more actuators to reduce the gripping span of the plurality of gripping devices.

Embodiment 15 is a robotic system for grasping objects, comprising: at least one processing circuit; and an end effector apparatus including: an actuator hub, a plurality of extension arms extending from the actuator hub in an at a least partially lateral orientation, a plurality of gripping devices arranged at corresponding ends of the extension arms, wherein the actuator hub includes one or more actuators couple to corresponding extension arms, the one or more actuators being configured to rotate the plurality of extension arms such that a gripping span of the plurality of gripping devices is adjusted, and a robot arm controlled by the at least one processing circuit and configured for attachment to the end effector apparatus, wherein the at least one processing circuit is configured to provide: a first command to cause at least one of the plurality of gripping devices to engage suction gripping, and a second command to cause at least one of the plurality of gripping devices to engage pinch gripping.

Embodiment 16 is the robotic system of embodiment 15, wherein the at least one processing circuit is further configured for selectively activating an individual gripping device of the plurality of gripping devices.

Embodiment 17 is the robotic system of any of embodiments 15-16, wherein the at least one processing circuit is further configured for engaging the one or more actuators for adjusting a span of the plurality of gripping devices.

Embodiment 18 is the robotic system of any of embodiments 15-17, wherein the at least one processing circuit is further configured for calculating a predicted flex behavior for a gripped object and planning a motion of the robot arm using the predicted flex behavior from the gripped object.

Embodiment 19 is a robotic control method, for gripping a deformable object, operable by at least one processing circuit via a communication interface configured to communicate with a robot having a robot arm that includes an end effector apparatus having a plurality of movable dual gripping devices, each dual gripping device including a suction gripping device and a pinch gripping device, the method comprising: receiving image information describing the deformable object, wherein the image information is generated by a camera; performing, based on the image information, an object identification operation to generate grasping information for determining an object grasping command to grip the deformable object; outputting the object grasping command to the end effector apparatus, the object grasping command comprising: a dual gripping device movement command configured to cause the end effector apparatus to move each of the plurality of dual gripping devices to a respective engagement position, each dual gripping device being configured to engage the deformable object when moved to the respective engagement position; a suction gripping command configured to cause each dual gripping device to engage suction gripping of the deformable object using a respective suction gripping device; and a pinch gripping command configured to cause each dual gripping device to engage pinch gripping of the deformable object using a respective pinch gripping device; and outputting a lift object command configured to cause the robot arm to lift the deformable object.

Embodiment 20 is a non-transitory computer-readable medium, configured with executable instructions for implementing a robot control method for gripping a deformable object, operable by at least one processing circuit via a communication interface configured to communicate with a robot having a robot arm that includes an end effector apparatus having a plurality of movable dual gripping devices, each dual gripping device including a suction gripping device and a pinch gripping device, the method comprising: receiving image information describing the deformable object, wherein the image information is generated by a camera; performing, based on the image information, an object identification operation to generate grasping information for determining an object grasping command to grip the deformable object; outputting the object grasping command to the end effector apparatus, the object grasping command comprising: a dual gripping device movement command configured to cause the end effector apparatus to move each of the plurality of dual gripping devices to a respective engagement position, each dual gripping device being configured to engage the deformable object when moved to the respective engagement position; a suction gripping command configured to cause each dual gripping device to engage suction gripping of the deformable object using a respective suction gripping device; and a pinch gripping command configured to cause each dual gripping device to engage pinch gripping of the deformable object using a respective pinch gripping device; and outputting a lift object command configured to cause the robot arm to lift the deformable object.

1. A robotic grasping system comprising:
an actuator arm;
a suction gripping device connected to the actuator arm; and
a pinch gripping device connected to the actuator arm.

2. The robotic grasping system of claim 1, wherein:
the suction gripping device is configured to apply suction to grip an object.

3. The robotic grasping system of claim 1, wherein:
the pinch gripping device is configured to apply a mechanical force to grip an object.

4. The robotic grasping system of claim 1, wherein the suction gripping device and the pinch gripping device are integrated together as a dual-mode gripper extending from the actuator arm.

5. The robotic grasping system of claim 4, wherein the suction gripping device is configured to apply suction to an object to provide an initial grip and the pinch gripping device is configured to apply a mechanical force to the object to provide a secondary grip.

6. The robotic grasping system of claim 5, wherein the pinch gripping device is configured to apply the mechanical force at a location on the object gripped by the suction gripping device.

7. The robotic grasping system of claim 6, wherein the suction gripping device is configured to apply the initial grip to a flexible object to raise a portion of the flexible object and the pinch gripping device is configured to apply the secondary grip by pinching the portion.

8. The robotic grasping system of claim 7, wherein the suction gripping device includes an extension actuator configured to extend a suction head of the suction gripping device to make contact with the flexible object and retract the suction head of the suction gripping device to bring the portion of the flexible object into a gripping range of the pinch grip device.

9. The robotic grasping system of claim 1, further comprising a plurality of additional actuator arms, each additional actuator arm including a suction gripping device and a pinch gripping device.

10. The robotic grasping system of claim 1, further comprising a coupler configured to permit the robotic grasping system to be attached to a robotic system as an end effector apparatus.

11. A robotic grasping system comprising:
an actuator hub;
a plurality of extension arms extending from the robotic hub in an at least a partially lateral orientation; and
a plurality of gripping devices arranged at ends of the plurality of extension arms.

12. The robotic grasping system of claim 11, wherein each of the plurality of gripping devices includes:
a suction gripping device; and
a pinch gripping device.

13. The robotic grasping system of claim 11, wherein:
the actuator hub includes one or more actuators coupled to the extension arms, the one or more actuators being configured to rotate the plurality of extension arms such that a gripping span of the plurality of gripping devices is adjusted.

14. The robotic grasping system of claim 13, further comprising:
at least one processing circuit configured to adjust the gripping span of the plurality of gripping devices by at least one of:
causing the one or more actuators to increase the gripping span of the plurality of gripping devices; and
causing the one or more actuators to reduce the gripping span of the plurality of gripping devices.

15. A robotic system for grasping objects, comprising:
at least one processing circuit; and
an end effector apparatus including:
an actuator hub,
a plurality of extension arms extending from the actuator hub in an at a least partially lateral orientation,
a plurality of gripping devices arranged at corresponding ends of the extension arms,
wherein the actuator hub includes one or more actuators couple to corresponding extension arms, the one or more actuators being configured to rotate the plurality of extension arms such that a gripping span of the plurality of gripping devices is adjusted, and
a robot arm controlled by the at least one processing circuit and configured for attachment to the end effector apparatus,
wherein the at least one processing circuit is configured to provide:
a first command to cause at least one of the plurality of gripping devices to engage suction gripping, and
a second command to cause at least one of the plurality of gripping devices to engage pinch gripping.

16. The robotic system of claim 15, wherein the at least one processing circuit is further configured for selectively activating an individual gripping device of the plurality of gripping devices.

17. The robotic system of claim 15, wherein the at least one processing circuit is further configured for engaging the one or more actuators for adjusting a span of the plurality of gripping devices.

18. The robotic system of claim 15, wherein the at least one processing circuit is further configured for calculating a predicted flex behavior for a gripped object and planning a motion of the robot arm using the predicted flex behavior from the gripped object.

19. A robotic control method, for gripping a deformable object, operable by at least one processing circuit via a communication interface configured to communicate with a robot having a robot arm that includes an end effector apparatus having a plurality of movable dual gripping devices, each dual gripping device including a suction gripping device and a pinch gripping device, the method comprising:
receiving image information describing the deformable object, wherein the image information is generated by a camera;
performing, based on the image information, an object identification operation to generate grasping information for determining an object grasping command to grip the deformable object;
outputting the object grasping command to the end effector apparatus, the object grasping command comprising:
a dual gripping device movement command configured to cause the end effector apparatus to move each of the plurality of dual gripping devices to a respective engagement position, each dual gripping device being configured to engage the deformable object when moved to the respective engagement position;
a suction gripping command configured to cause each dual gripping device to engage suction gripping of the deformable object using a respective suction gripping device; and
a pinch gripping command configured to cause each dual gripping device to engage pinch gripping of the deformable object using a respective pinch gripping device; and
outputting a lift object command configured to cause the robot arm to lift the deformable object.

20. A non-transitory computer-readable medium, configured with executable instructions for implementing a robot control method for gripping a deformable object, operable by at least one processing circuit via a communication interface configured to communicate with a robot having a robot arm that includes an end effector apparatus having a plurality of movable dual gripping devices, each dual gripping device including a suction gripping device and a pinch gripping device, the method comprising:
receiving image information describing the deformable object, wherein the image information is generated by a camera;
performing, based on the image information, an object identification operation to generate grasping information for determining an object grasping command to grip the deformable object;
outputting the object grasping command to the end effector apparatus, the object grasping command comprising:
a dual gripping device movement command configured to cause the end effector apparatus to move each of the plurality of dual gripping devices to a respective engagement position, each dual gripping device being configured to engage the deformable object when moved to the respective engagement position;
a suction gripping command configured to cause each dual gripping device to engage suction gripping of the deformable object using a respective suction gripping device; and
a pinch gripping command configured to cause each dual gripping device to engage pinch gripping of the deformable object using a respective pinch gripping device; and
outputting a lift object command configured to cause the robot arm to lift the deformable object.
